(19) United States
(12) Patent Application Publication
(10) Pub. No.: US 2020/0307616 A1
(43) Pub. Date: Oct. 1, 2020

(54) METHODS AND SYSTEMS FOR DRIVER ASSISTANCE

(71) Applicant: DENSO TEN AMERICA Limited, Novi, MI (US)

(72) Inventors: Mayunthan NITHIYANANTHAM, Novi, MI (US); Jacob GEDDES, Livonia, MI (US); Hongwei ZHONG, Northville, MI (US)

(73) Assignee: DENSO TEN AMERICA Limited, Novi, MI (US)

(21) Appl. No.: 16/365,154

(22) Filed: Mar. 26, 2019

(51) Int. Cl. B60W 50/14; G02B 27/01

(52) U.S. Cl. CPC B60W 50/14; G02B 27/017; B60W 2550/406; B60W 2420/42; B60W 2550/402; B60W 2050/146

(57) ABSTRACT

A driver assistance system includes a processor and a memory. The memory stores instructions that when executed by the processor cause the processor to receive global positioning system (GPS) data from a GPS receiver, and receive image data from at least one camera. The image data includes images of an environment external to the vehicle. The instructions further cause the processor to receive sensor data from a plurality of sensors, determine a visual alert to display to a driver of the vehicle based at least in part on one or more of the GPS data, the image data, and the sensor data, determine a display position for the visual alert; and output the visual alert and the display position to a driver-wearable see-through augmented reality device.

### BACKGROUND

This disclosure relates generally to the field of driver assistance systems and methods of providing driver assistance. More particularly, this disclosure relates to driver assistance systems and methods that utilize a driver-wearable see-through augmented reality (AR) device to provide assistance to the driver.

At least some known systems provide assistance to a driver of a vehicle by displaying assistive information, such as driving directions to a destination, vehicle speed, local speed limit, or vehicle information on a display device mounted in the vehicle. This display device is generally located on a console or instrument cluster of the vehicle and requires that the driver to look away from the road in order to view the assistive information.

At least some other known systems provide assistance to a driver of a vehicle by displaying on side mirrors and/or on the rearview mirror alerts of another vehicle close to the side of the driver's vehicle. Such alerts may also require the user to look away from the road to see the alert and/or may be distracting.

### SUMMARY

One aspect of this disclosure is a driver assistance system. The driver assistance system includes a processor and a memory. The memory stores instructions that when executed by the processor cause the processor to receive global positioning system (GPS) data from a GPS receiver, and receive image data from at least one camera. The image data includes images of an environment external to the vehicle. The instructions further cause the processor to receive sensor data from a plurality of sensors, determine a visual alert to display to a driver of the vehicle based at least in part on one or more of the GPS data, the image data, and the sensor data, determine a display position for the visual alert; and output the visual alert and the display position to a driver-wearable see-through augmented reality (AR) device.

Another aspect of this disclosure is a method of providing driver assistance. The method includes receiving, by a processor, global positioning system (GPS) data from a GPS receiver, and receiving, by the processor, image data from at least one camera. The image data includes images of an environment external to the vehicle. The method further includes receiving, by a processor, sensor data from a plurality of sensors, determining, by the processor, a visual alert to display to a driver of the vehicle based at least in part on one or more of the GPS data, the image data, and the sensor data, determining, by the processor, a display position for the visual alert, receiving, by a driver-wearable see-through augmented reality (AR) device, the visual alert and the display position from the processor, and displaying, on a see-through display of the AR device, the visual alert at the display position.

### BRIEF DESCRIPTION OF THE DRAWINGS

The disclosure will be described with reference to the accompanying drawings, wherein like numbers reference like elements.

FIG. 1 is a block diagram of an example driver assistance system (DAS) according to the present disclosure.

FIG. 2 is a block diagram of an example MAV unit of the DAS of FIG. 1.

FIG. 3 is a diagram of an augmented reality (AR) module and the MAV unit of the DAS of FIG. 1.

FIG. 4 is a flow diagram of an example method performed by the DAS using the AR system of FIG. 3.

FIG. 5 is a simulated view of a driver using the AR system of FIG. 3.

FIG. 6 is another simulated view of a driver using the AR system of FIG. 3.

FIG. 7 is a flow diagram of a method performed by a driving assistant module of the DAS of FIG. 1.

FIG. 8 is a flow diagram of a method of lane change prediction and automatic turn signal activation for the method of FIG. 7.

FIG. 9 is a flow diagram of a method of driver behavioral monitoring for the method of FIG. 8.

FIG. 10 is a flow diagram of a method of driver path prediction for the method of FIG. 8.

FIG. 11 is a flow diagram of a method of driver routine path and destination analysis for the method of FIG. 10.

FIG. 12 is a flow diagram of a method performed by a parking assistant module of the driver assistance system of FIG. 1.

FIG. 13 is a flow diagram of a method of parking assist activation for the method of FIG. 12.

FIG. 14 is a flow diagram of a method of parking space detection for the method of FIG. 12.

FIG. 15 is an example split view showing parking areas near a driver's destination displayed to a driver as part of the method of FIG. 14.

FIG. 16 is an example top view showing available parking spaces within a selected parking area displayed to a driver as part of the method of FIG. 14

FIG. 17 is an example split view that may be displayed to a driver to guide the driver to park in a selected parking space as part of the method of FIG. 12.

### DETAILED DESCRIPTION OF EMBODIMENTS

Example embodiments of the methods and systems described herein provide assistance to a driver of a vehicle. More particularly, at least some embodiments provide driver assistance utilizing a driver-wearable see-through augmented reality (AR) device to provide assistance to the driver.

At least some embodiments of the present disclosure may help avoid distracted driving and increase safety and efficiency of a vehicle. In such embodiments, the vehicle is enhanced so that danger can be detected and avoided in advance. The embodiments may assist drivers to safely and efficiently maneuver their vehicle to their destination. At least some embodiments enhance a vehicle driver's perceptions of the surrounding environment, resolve vision problems by utilizing vehicle's perception, and providing novel methods to maneuver the vehicle safely in the environment.

Various embodiments of systems in this disclosure include one or more of three different assistance modules: a driving assistant module, a parking assistant module, and a guidance system module.

The driving assistant module provides assistance to a driver while driving (e.g., not parking) a vehicle. Among other things, the driving assistant module predicts a driver's intention to change lanes and applies the vehicle turn signal, even if the driver does not activate it. Additionally, the driving assistant module enhances collision avoidance and object detection.

The parking assistant module provides assistance to the driver of the vehicle while parking a vehicle. The parking assistant module, in part, predicts the driver's intention to park, detects parking spaces, and aids the driver in efficiently maneuvering into a parking spot.

The guidance system module provides the main connection of the driver to the vehicle, increasing their perception of the surrounding even if they are distracted. The guidance system module also interfaces an augmented reality (AR) system to the vehicle. Interfacing AR glasses with the vehicle may enhance the driver's perception and help improve the driver's attention on the road.

The embodiments of this disclosure generally provide semi-autonomous assistance to the driver. That is, rather than a fully-autonomous (or self-driving) vehicle that control steering, braking, acceleration, and the like, the example assistance systems described herein provide drivers with assistance and guidance to allow the driver to maneuver their vehicle safely to their destination with less effort and control a limited number of vehicle systems (e.g., the turn signals). The systems increase visual and audial perception of the surrounding environment and determine automatically any plausible hazards that could potentially disrupt their driving experience. At least some embodiments map the vehicle surroundings, calculate the most efficient path to the driver's destination, and provide drivers with visual and audial guidance to safely reach their desired destination.

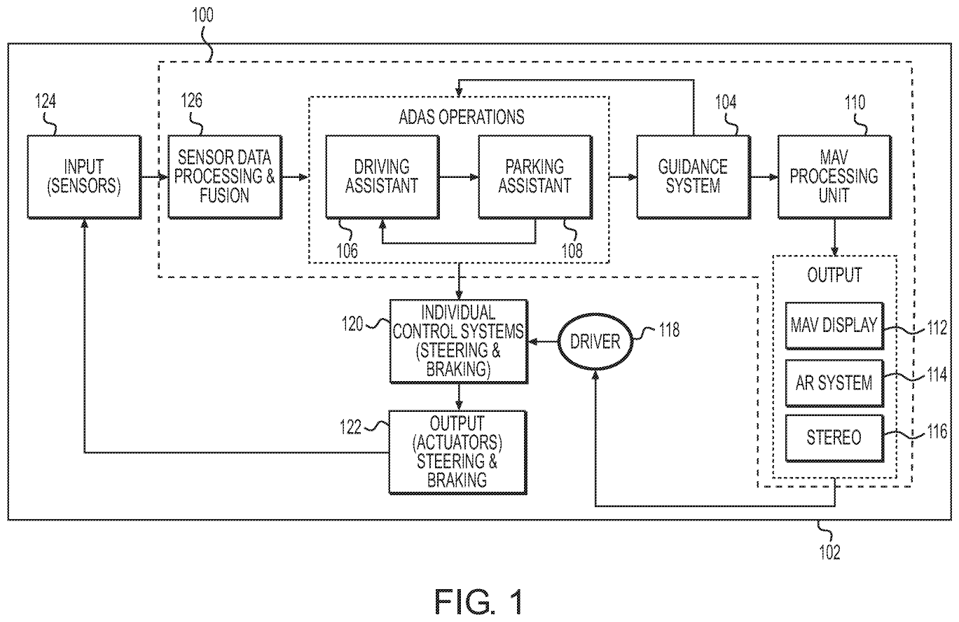

Turning now to the figures, FIG. 1 is a block diagram of an example driver assistance system (DAS) 100 according to the present disclosure. The DAS 100 is installed in a vehicle 102. In the example embodiment, the vehicle 102 is a car. In other embodiments, the vehicle may be a truck, a van, a bus, a motorcycle, a scooter, or any other suitable vehicle. In still other embodiments, with appropriate modifications, some or all of the features described herein are used in vehicle 102 that is a boat, a piece of farm equipment (such as a tractor), a snowmobile, a jet-ski, or any other suitable vehicle that is not primarily operated on roadways.

The DAS system 100 includes a guidance system module 104, a driving assistant module 106, and a parking assistant module 108. The guidance system module 104, the driving assistant module 106, and the parking assistant module 108 may be implemented in hardware, software, or a combination of hardware and software. A multi-angle view (MAV) processing unit 110 (sometimes referred to herein as the MAV unit 110) functions as the controller of the DAS 100. The MAV unit 110 selectively provides output to a MAV display 112, an AR system 114, and an audio (stereo) system 116. Although the MAV unit 110, the MAV display 112, the AR system 114, and the audio system 116 are illustrated as part of the DAS system, in other embodiments some or all of these components may be not be part of the DAS system, may additionally be part of other systems, or may not be separate systems.

The AR system 114 will be described in further detail below. The MAV display 112 is a liquid crystal display (LCD), a light emitting diode (LED) display, an organic LED (OLED) display, a passive matrix light emitting diode (PMOLED) display, an “electronic ink” display, or any other suitable display device. In some embodiments, the MAV display 112 is a touch screen display that also functions as an input device for user interaction with the MAV unit 110. The audio system 116 is the vehicle's audio system including, for example, a receiver and speakers (not shown).

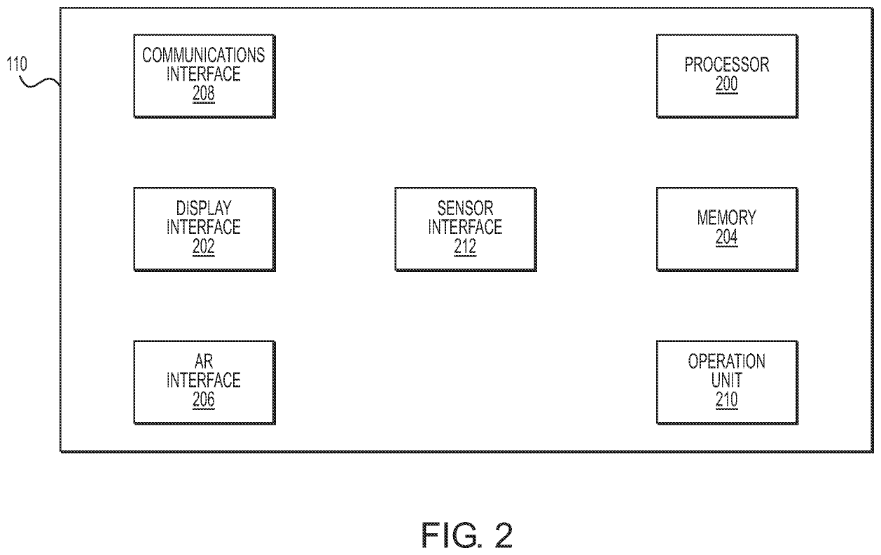

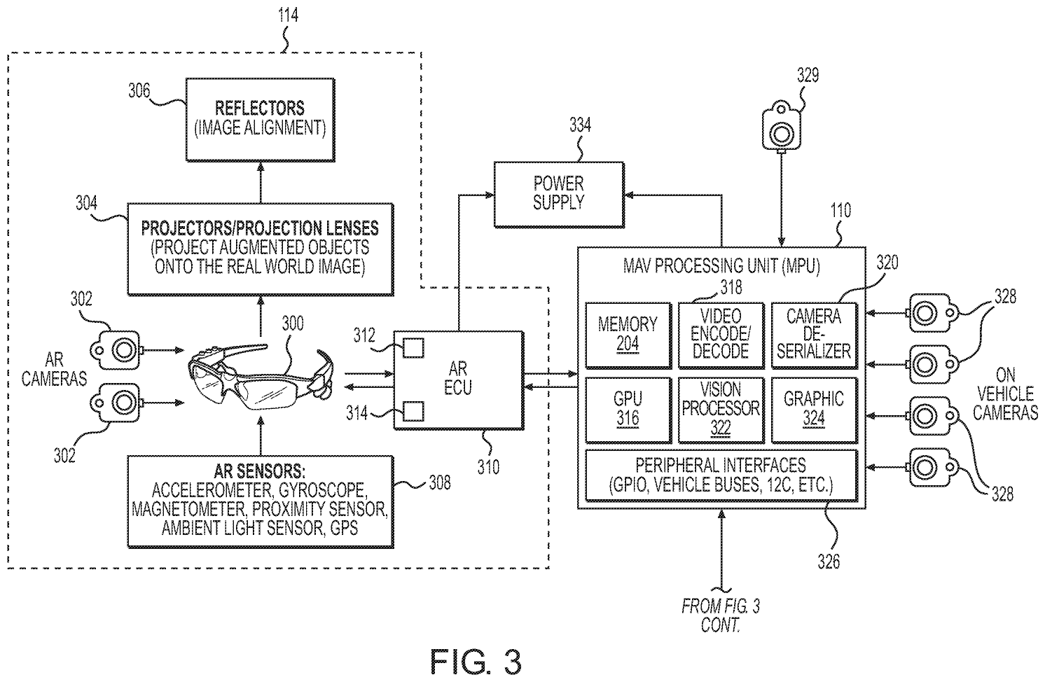

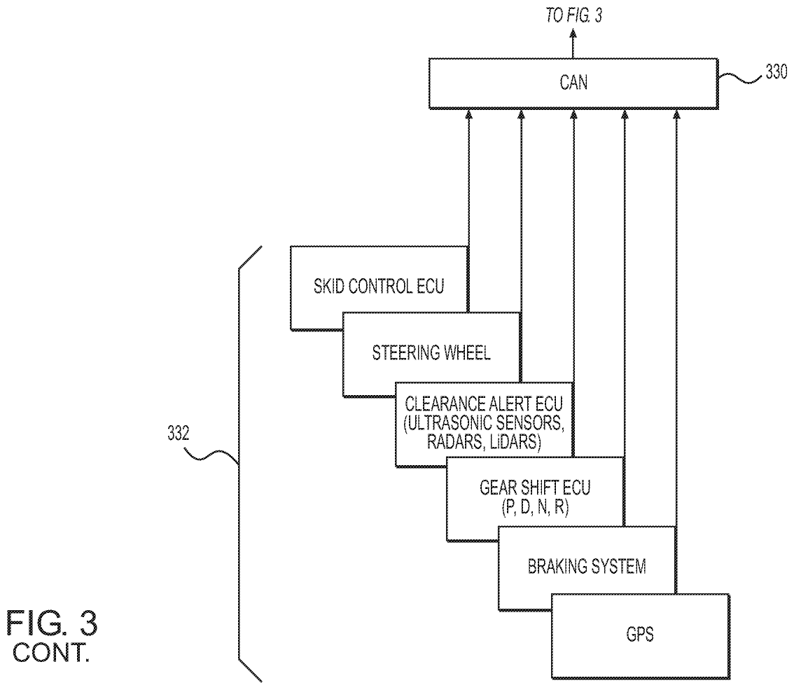

FIG. 2 is a block diagram illustrating a functional configuration of the MAV unit 110 in the present embodiment which performs the methods described herein. The MAV unit 110 includes a processor 200, a display interface 202, a memory 204, an AR interface 206, a communications interface 208, an operation unit 210, and a sensor interface 212. As seen, for example, in FIG. 3, the MAV unit may include different components, additional components, fewer components, other components may be part of the components shown in FIG. 2, or some of the components shown in FIG. 2 may be part of other components.

The processor 200 performs the processing for MAV unit 110. The processor 200 is, for example, a micro processing unit (MPU), a digital signal processor (DSP), an application specific integrated circuit (ASIC), a central processing unit (CPU), field programmable gate array (FPGA), a programmable logic controller (PLC), a microcontroller, a graphics processing unit (GPU), or any other suitable processor. Additionally, the processor may have a single processor architecture, a multi-processor architecture, a sequential (Von Neumann) architecture, a parallel architecture, or any other suitable architecture or combination of architectures. The memory 204 stores various items of data and programs. The programs include instructions that, when executed by the processor 200, cause the processor to perform some actions, for example the various methods described herein. The memory 204 may be any suitable non-transitory computer readable storage medium, data storage device or devices, and may comprise a hard disk and/or solid state memory (such as flash memory). The memory 204 may include permanent non-removable memory, and/or removable memory, such as a random access memory (RAM), read only memory (ROM), secure digital (SD) memory card, a Universal Serial Bus (USB) flash drive, other flash memories (such as NOR, NAND or SPI flash), a compact disc (CD), a digital versatile disc (DVD) or a Blu-ray disc.

The display interface 202 couples the MAV unit 110 to the display 112 to allow the MAV unit 110 to display information to the driver 118 through the display 112. The communications interface 208 includes one or more interfaces for performing a variety of types of control for establishing data communication between the MAV unit and external devices, such as for exchanging data, retrieving software updates, uploading data for storage, retrieving maps and/or mapping data/retrieving directional information, or the like. The communications interface 208 may include wired and/or wireless communications interfaces. The communications interface 208 may include one or more interfaces for wireless communication (such as by communication over a wireless telecommunications network, telematics, or another data network) to remotely located device(s) outside of the vehicle 102, such as a remotely located computer, the Internet, and the like. The communications interface 208 may include one or more interfaces for wired or wireless communication with a device located within the vehicle 102, such as the driver's cell phone, tablet computer, laptop computer, smart watch, or the like. The sensor interface 212 communicatively couples the MAV unit 110 to a plurality of sensors. The sensor interface may include any suitable combination of wired and/or wireless interfaces for communicating with sensors. In some embodiments, the communications interface 208 includes and/or functions as the sensor interface 212.

The operation unit 210 is a user interface (GUI) for receiving an operation from a user. The operation unit 210 is formed, for example, of buttons, keys, a microphone, a touch panel, a voice recognition function, or any other suitable driver interaction device for receiving an instruction from the driver 118.

The AR interface 206 is an interface for communicative connection to the AR system 114. In the example embodiment, the AR interface is a wired interface. In other embodiments, the AR interface may be any wired or wireless interface suitable for establishing a data connection for communication between the MAV unit 110 and the AR system. The AR interface may be, for example, a Wi-Fi transceiver, a USB port, a Bluetooth® transceiver, a serial communication port, a proprietary communication port, or the like. In some embodiments, UDP or TCP protocols are used for wireless transfer. In other embodiments, any other suitable communication protocol may be used.

Returning to FIG. 1, a human driver 118 in the vehicle 102 receives the output of the MAV unit 110 through the MAV display 112, the AR system 114, and/or the audio system 116 and operates the vehicle's control systems 120. The vehicle's control system 120 outputs data (control system output 122) that is used by the DAS system 100. For example, the vehicle's steering system, braking system, and acceleration system output signals indicating their present state (e.g., the position of the steering wheel). The individual control systems are responsible for the actual output of the vehicle, e.g., the actuators, that is responsible for the vehicle's dynamic motion in the environment. Other controls, such as headlights, windshield wipers, turn signals, and the like, may also output data as part of the control system output 122 as well.

The control system output and the output of other sensors (not shown in FIG. 1) serve as an input 124 to the DAS system 100. The other sensors may include any suitable combination of other (non-control system) vehicle sensors, sensors of the AR system, sensors worn by the driver 118 (such as a smart watch, a fitness tracker, or the like), and/or sensors of a portable device (such as a smartphone, tablet computer, laptop computer, or the like). The other sensors may include cameras, ultrasonic sensors, radar systems, LIDAR systems, GPS sensors (also referred to as GPS receivers), gyroscopes, accelerometers, magnetometers, one or more inertial measurement units (IMUs). The received sensor data is processed by a sensor data processing and fusion unit 126. The fusion unit 126 fuses AR proximity sensor data with depth camera perception, fuses AR inertial measurement unit (IMU) data, proximity calculations, and AR gray scale captures to calculate the motion and position of the driver's head, hands, and the surrounding environment, and fuses GPS, radar, sonar, and LIDAR information with the above to evaluate position of the vehicle, calculate path trajectory and provide accurate guidelines to follow. The processed sensor data is then provided for use by the modules 104, 106, 108, and the MAV unit 110. Although included above as a type of sensor that produces sensor data, cameras may be considered separate from other sensors and described sometimes herein as cameras that produce image data. It should be understood that images and image data generally refer to video, rather than still images, (or a stream of still images that when viewed sequentially over time form a video image) throughout this disclosure except where context requires otherwise.

FIG. 3 is a diagram of a portion of the DAS 100 including the AR system 114 and the MPU 110.

The AR system 114 is a driver-wearable see-through AR device. The AR system 114 includes a pair of AR glasses 300 to be worn by the driver 118. The AR glasses 300 are an optical transmission type. That is, the AR glasses can cause the driver 118 to sense a virtual image and, at the same time, allow the driver 118 to directly visually recognize an outside scene. For ease of illustration and description, various components of the AR glasses 300 are shown separate from the AR glasses 300, but are included as part of the AR glasses, as describe below.

Cameras 302 are mounted to the AR glasses 300 and function as an imaging section. In the example embodiment, the AR glasses 300 include two cameras 302, which allows stereoscopic image capture and may provide a wider field of view for the cameras 302. Other embodiments utilize a single camera. The cameras 302 are capable of imaging an outside scene. The cameras 302 are configured to image an outside scene, which is a real scene on the outside in a line of sight direction of the user, and acquire a captured image of the outside scene. The cameras 302 capture forward-view image data, which is image data that approximates the forward-view of the driver 118. In some embodiments, the AR glasses include at least one camera positioned to capture an image of the driver's eyes, to track the movement and location of the driver's eyes relative to the AR glasses 300.

Projectors and projection lenses 304 on the AR glasses 300 cooperatively display virtual objects onto the real world image that the user views through the AR glasses 300. Reflectors within the AR glasses 300 provide image alignment to align the virtual objects with the real world image.

A variety of sensors 308 are included in the AR glasses 300. The sensors may include, for example, an inertial measurement unit (IMU), an accelerometer, a gyroscope, a magnetometer, a proximity sensor, an ambient light sensor, a GPS receiver, or the like. Generally, the sensors 308 detect the position, movement, and orientation of the AR glasses, and the conditions around the AR glasses. Other embodiments may include more or fewer and/or different sensors.

An AR electronic control unit (ECU) 310 functions as the controller for the AR glasses 300 and the AR system 114. The AR ECU includes a processor 312 and a memory 314. The memory stores instructions (e.g., in programs) that cause the processor to perform actions, such as the methods described herein.

The processor 312 is, for example, a micro processing unit (MPU), a digital signal processor (DSP), an application specific integrated circuit (ASIC), a central processing unit (CPU), field programmable gate array (FPGA), a programmable logic controller (PLC), a microcontroller, a graphics processing unit (GPU), or any other suitable processor. Additionally, the processor 312 may have a single processor architecture, a multi-processor architecture, a sequential (Von Neumann) architecture, a parallel architecture, or any other suitable architecture or combination of architectures. The memory 314 may be any suitable non-transitory computer readable storage medium, data storage device or devices, and may comprise, for example, solid state memory (such as flash memory). The memory 314 may include permanent non-removable memory, and/or removable memory, such as a secure digital (SD) memory card, or a Universal Serial Bus (USB) flash drive.

The AR ECU 310 performs the functions needed to operate the AR system 114 to display virtual images to the driver 118 on the AR glasses. The control and operation of AR glasses are known to those of skill in the art and will not be described herein in detail. Generally, the AR ECU causes the AR glasses 300 to display an image at a display position on the lenses of the AR glasses 300 so that the driver perceives the displayed image as being located at a corresponding location in the real world. That is, ideally, the displayed image appears to the driver as if it is located in the real world, rather than appearing as an image on a computer screen. Additionally, the AR ECU 310 performs object detection and tracking to detect real world objects and track their position relative to the AR glasses 300 and the driver 118. This allows, among other things, a virtual image to be displayed on the AR glasses 300 at a display location that corresponds to the real world location (that is a position that causes the image to be perceived by the driver 118 as being located at the corresponding real world location) and to maintain the correspondence (by determining an updated display position) even as the driver 118 moves his head to change his line of sight. The AR ECU performs this object detection and tracking, and through use of the images from the cameras and the outputs of the sensors 308. Object detection and/or tracking may use, for example, feature detection to detect and keep note of interest points, fiducial markers, or optical flow in the images. Methods may include one or a combination of the corner detection, blob detection, and edge detection or thresholding. Other embodiments may use other techniques.

In the example embodiment, the virtual images displayed to the driver by the AR system 114 are visual alerts related to operation of the vehicle 102. The visual alerts can include operating conditions of the vehicle 102, such as the current speed of the vehicle, the direction of travel of the vehicle, the amount of fuel remaining in the vehicle, any vehicle operation warnings or indicators (such as a check engine warning, a low fuel warning, a low battery voltage, or the like), or any other suitable alerts related to the operating condition of the vehicle 102 itself. The visual alerts related to operating conditions of the vehicle are generally not specific to any real-world location as viewed by the driver 118 and may be displayed in a fixed, predetermined display position on the AR glasses 300 (such that the visual alert is always in the bottom right hand corner of the driver's view) or may be tied to a predetermined real-world position (such as by having the current speed be displayed at a display position to fixedly correspond to a real-world position in the center of the hood of the vehicle 102).

The visual alerts may additionally or alternatively include alerts related to the location of the vehicle 102 and/or the destination of the vehicle 102. For example, the visual alerts may include the current location of the vehicle 102, a distance of the vehicle 102 from a destination of the vehicle, driving directions/guidance to a destination of the vehicle, a speed limit at the vehicle's current location, identification of a destination (if visible in the driver's field of view), identification of upcoming or visible location based (e.g., fixed location items, such as buildings) items of interest or concern, or the like. Upcoming items of interest or concern can include, for example, buildings or other landmarks of interest, upcoming stop signs, upcoming traffic lights, upcoming intersections, or the like. Location related visual alerts are generally displayed at a display position to correspond to the real world location to which they correspond. That is, a visual alert identifying a building of interest or a destination location will be displayed so as to appear to the driver as if the visual alert was located at the building of interest or the destination location. Location related visual alerts are generally based, at least in part, on GPS data from the AR system's GPS sensor, a GPS sensor of the vehicle 102, or a GPS sensor of a portable device of the driver 118.

The visual alerts may additionally or alternatively include warnings or notifications related to driving conditions around the vehicle 102. For example, the warnings can include warnings about the presence of another vehicle less than a threshold distance away from the vehicle 102 (particularly within the driver's ‘blind spot’ to the rear sides of the vehicle 102), the presence of objects such as pedestrians, cyclists, or deer, near or approaching the vehicle 102 or the path of the vehicle, the location of nearby accidents or traffic slow-downs, the presence of any object near the vehicle 102, or the like.

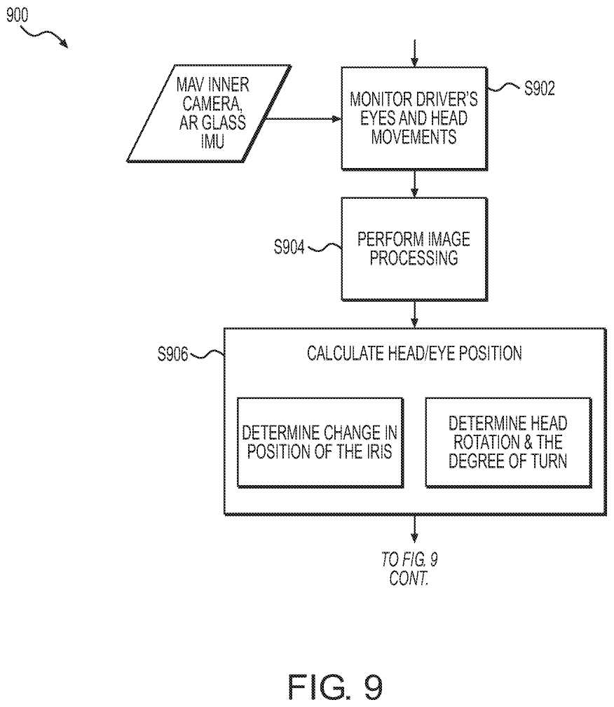

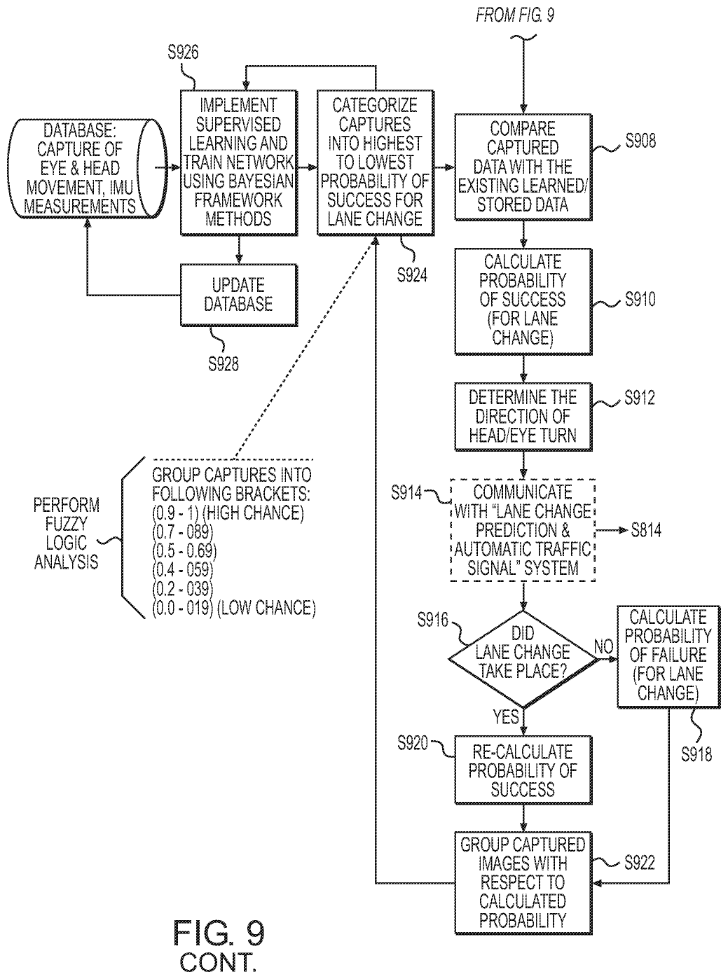

In the embodiment shown in FIG. 3, the MAV unit 110 includes the memory 204, a GPU 316, a video encoder/decoder 318, a camera deserializer 320, a vision processor 322, graphics 324, and peripheral interfaces 326. The graphics 324 is 3D/2D graphics engine, containing graphics libraries and rendering instructions. More, in the example embodiment, Open GL ES 3.0 is utilized. The graphics 324 also include stored graphics (for example, visual signs) that will be displayed onto the AR glasses 300. The MAV unit 110 is connected to vehicle cameras 328 and interior camera 329. Image data from the vehicle cameras 328 is used by the MAV unit for display of the environment around the vehicle to the driver 118, for example on MAV display 112. The image data from the vehicle cameras 328 may also be used for detection of objects around the vehicle 102. The interior camera 329 is positioned to capture images of the driver 118 and is used as part of the driver behavioral monitoring discussed below with respect to FIG. 9. The peripheral interfaces, which are included in the sensor interface 212 and/or the communications interface 208, are connected to the vehicle's controller area network (CAN) bus 330 to receive data from vehicle systems and sensors 332. Additionally or alternatively, communications interface 208 and/or sensor interface 212 may be connected to a media oriented systems transport (MOST) bus, and/or an Ethernet connection. Further, communication may be performed using general purpose input output (GPIO) or Standard I/O, such as inter-integrated circuit (I²C) , inter-IC sound (I²S) , universal asynchronous receiver-transmitter (UART), or serial peripheral interface (SPI). The vehicle systems and sensors 332 communicatively coupled to the MAV unit 110 via the CAN bus 330 include a skid control ECU, the steering wheel, a clearance alert ECU, a gear shift ECU, the braking system, and a GPS receiver. The clearance alert ECU processes data from proximity sensors such as ultrasonic sensor, radar, LIDAR, or other sensors and systems suitable for detecting objects near the vehicle 102.

The MAV unit 110 and the AR system 114 are both powered by power supply 334. In the example embodiment, the power supply 334 is the vehicle's electrical system, and, more specifically, the vehicle's battery and/or output of the vehicle's alternator. In other embodiments, the MAV unit 110 and the AR system 114 may be powered by separate power supplies.

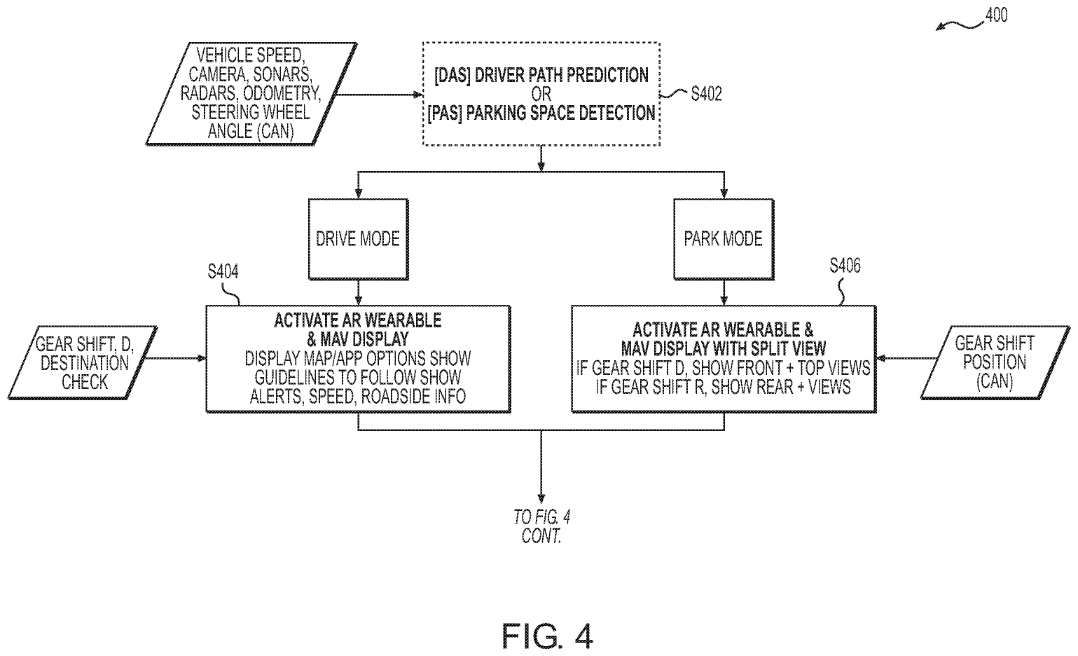

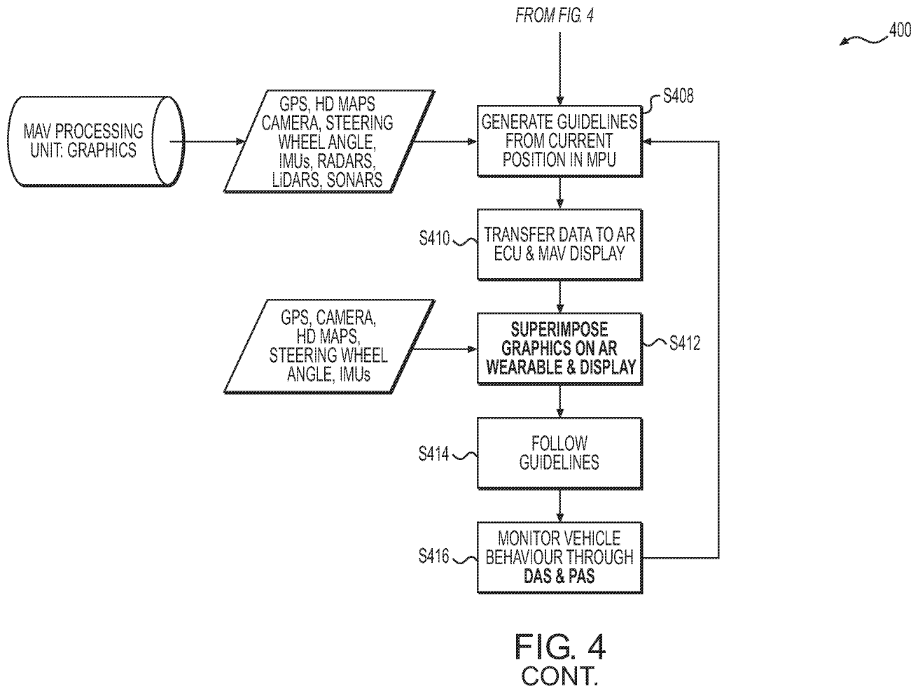

FIG. 4 is a flow diagram of an example guidance method 400 performed by the DAS 100 using the AR system 114. At S402, the DAS 100 determines whether to perform driver path prediction or parking space detection. These decisions will be discussed in more detail further below.

If driver path prediction is performed, the DAS 100 operates in drive mode. If parking space detection is performed, the DAS operates in park mode.

In drive mode, at S404, the DAS 100 retrieves data from the gear shift ECU to determine that the vehicle 102 is in drive, identifies a destination of the vehicle 102 (if available), and activates the AR glasses 300 and the MAV display 112 to display driving assistance to the driver 118. Driving assistance may be provided even if the destination is unknown. However, in such circumstances, guidance information to the destination cannot be provided to the driver 118.

In the park mode, at S406, the DAS 100 retrieves data from the gear shift ECU to determine that the vehicle 102 is in drive or in reverse and activates the AR glasses 300 and the MAV display 112 to display driving assistance to the driver 118. If the vehicle is in drive, the DAS 100 displays front (i.e. forward) and top views of the environment around the vehicle 102 captured by the vehicle cameras 328 on the MAV display 112. If the vehicle is in reverse, the DAS 100 displays rear and top views of the environment around the vehicle 102 captured by the vehicle cameras 328 on the MAV display 112.

The remaining steps of method 400 are the same in park mode and drive mode. At S408, the MAV unit 110 retrieves sensor data (e.g., from the vehicle systems and sensors 332), determines the current position of the vehicle 102, determines a route from the current location of the vehicle 10 to the destination (whether a parking space or a driving destination), and generates graphical guidelines (which are an example of a visual alert) to guide the vehicle to the destination. The graphical guidelines are generated based on the image data from the cameras 328 and the cameras 302 of the AR glasses 300. That is, the guidelines are generated to be appropriately displayable over the images captured by the cameras 302 and 328 to guide the user to the destination. For example, a different graphical guideline is needed to indicate that the driver 118 should drive straight ahead when displayed on a top view image than will be needed to convey the same information on a front view image captured by the cameras 328 or 302. Moreover, the graphical guidelines for the top view will generally be 2D, whereas the graphical guidelines for the front or rear view (or for display on the AR glasses 300) will generally be 3D graphical guidelines.

The MAV unit 110 transfers (S410) the appropriate generated guidelines to the MAV display 112 and the AR ECU 310. The MAV display 112 displays the guidelines superimposed on top view and front or rear images being displayed on the MAV display 112. In S412, the AR ECU 310 displays the graphics on the lenses of the AR glasses 300. As noted above, such virtual images are displayed on the AR glasses at a determined display position to correspond to a real-world position in the view of the driver 118. The MAV unit 110 and/or the AR ECU 310 determines the display position. In some embodiments, the MAV unit 110 determines a display position relative to an image from the AR cameras 302, and the AR ECU 310 determines a display position on the lenses of the AR glasses 300 that, as viewed by the driver 118, corresponds to the display position determined by the MAV unit 110.

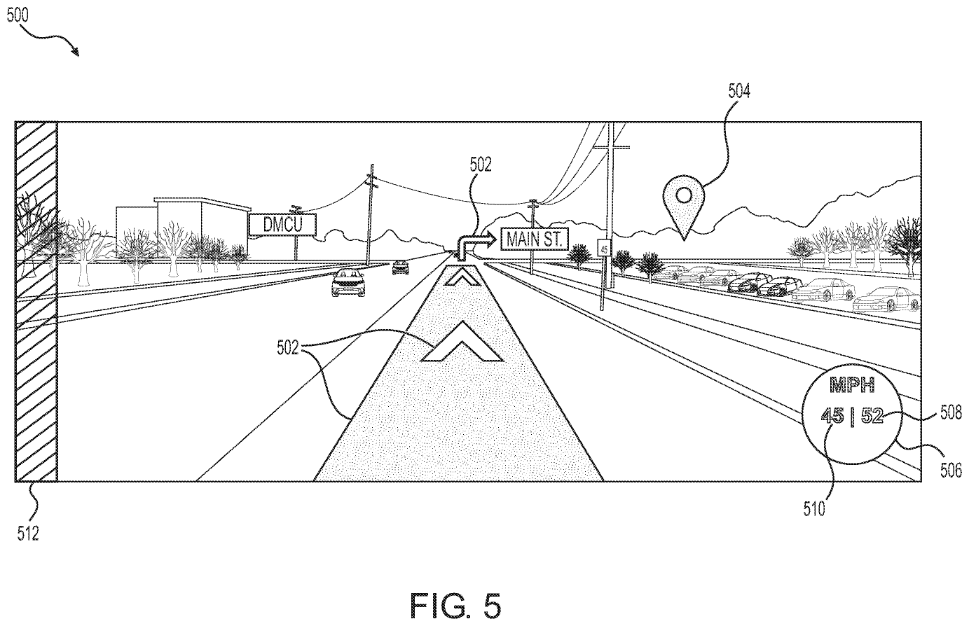

FIG. 5 is a simulated view 500 of a driver wearing the AR glasses 300 at such a time. The image of the road, other vehicles, buildings, trees, etc. is the real-world view of the driver through the lenses of the AR glasses 300. Several visual alerts are projected onto the lenses of the AR glasses 300 can be seen in the simulated view. Guidelines 502 are displayed to guide the driver 118 to the destination marked by a destination visual alert 504. The guidelines 502 in this particular display include guidelines highlighting the path that the vehicle 102 should travel, arrows indicating the direction of travel, and an arrow indicating where the driver 118 needs to turn. The street at which the driver 118 will make the turn (i.e., Main Street) is also indicated by a visual alert. As can be seen, the driver 118 needs to continue straight and then turn right on Main Street to reach the destination. Additionally, a speed visual alert 506 displays the vehicle's current speed 508 and the speed limit 510 for the current location of the vehicle 102. A nearby location of interest (the DMCU) is also marked by a visual alert 508. Any other major buildings, points of interest, landmarks, or other items of interest to the driver may be marked. Alternatively, the DMCU may be the driver's destination, and the destination visual alert 504 may mark the location of the parking lot for the DMCU. A visual alert 512 displayed on the left side of the AR glasses 300 indicates that an object is located on the left side of the vehicle 102. The visual alert 512 may be a flashing alert to improve the chances of the driver 118 noticing the visual alert 512.

The guidelines and other visual alerts displayed on the AR glasses 300 are not opaque. The real-world is still visible to the driver through the guidelines and other visual alerts. Thus, the driver is able to maintain the ability to keep her eyes on the road and completely see the real-world in front of the vehicle 102, while still receiving the information conveyed by the visual alerts.

The AR ECU 310 updates the display position of the visual alerts repeatedly to maintain the correspondence of the visual alerts to locations in the real-world in the view of the driver 118, even if the driver moves her head. Thus, for example, if the user turns her head to the left, the AR ECU 310 will update the display position of the guidelines 502 on the AR glasses 300 to positions to the right of the display positions illustrated in FIG. 5, so that the guidelines 502 will still appear to the user to be located at the real world positions with which they correspond. Updating the display position may include updating the display position to not display on the AR glasses 300. For example, if the driver looked far enough to the left, the real-world location marked by the destination visual alert 504 may not be visible to the driver. In such an instance, the AR ECU may update the display position of the alert 504 to be not displayed on the AR glasses. Alternatively, some variation of the alert 504 may be displayed at the far right of the AR glasses to indicate to the driver 118 that the destination is located to her right, but is not within her field of view.

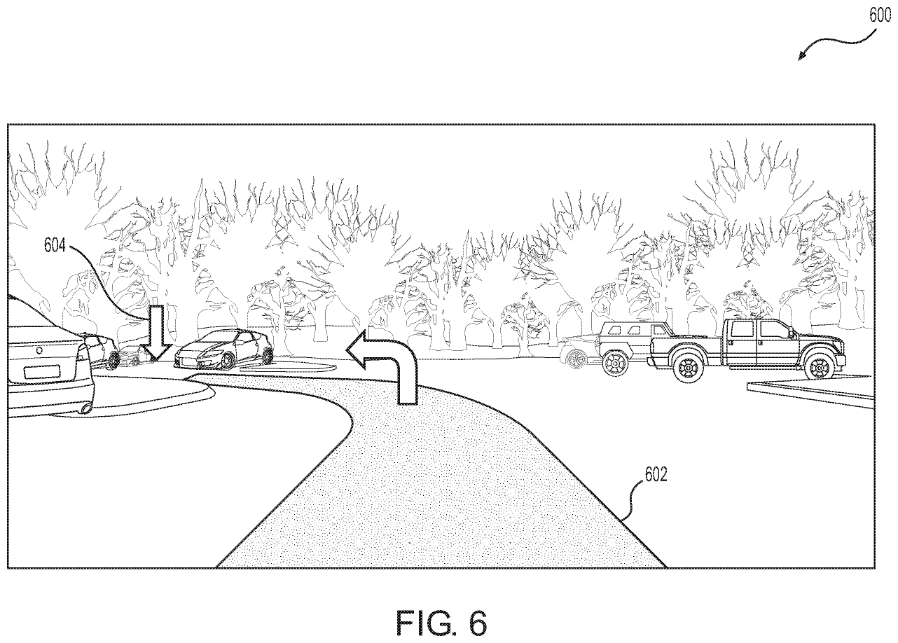

FIG. 6 is a simulated view 600 of a driver wearing the AR glasses 300. In this simulated view, the driver is parking the vehicle 102. In this figure, the guidelines 602 guide the driver 118 to an available parking space indicated by the arrow 604.

Returning to FIG. 4, the driver follows the guidelines on the AR glasses 300 and/or the MAV display 112 in S414. In S416, the DAS 100 monitors the vehicle behavior through the process (via the vehicle sensors and systems, etc.), and the method 400 returns to S408 to generate updated guidelines.

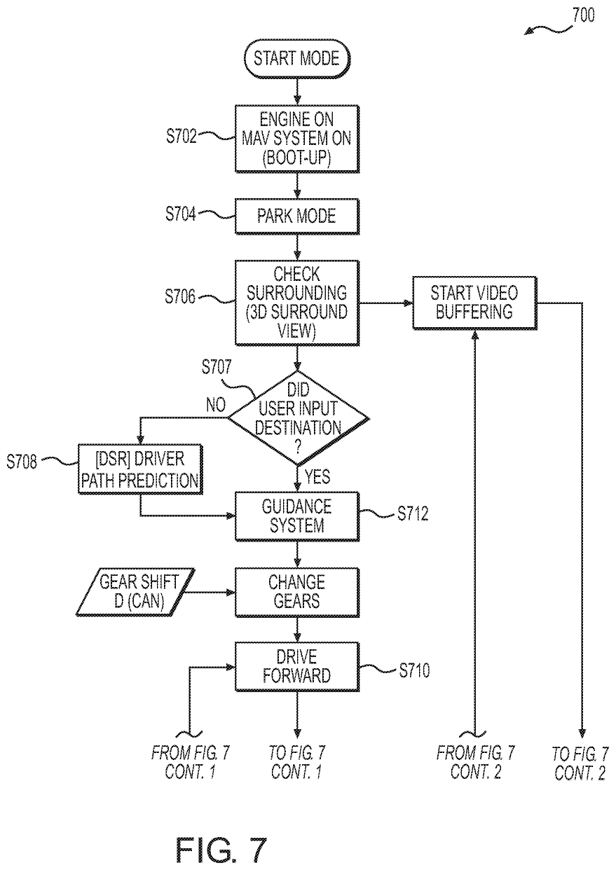

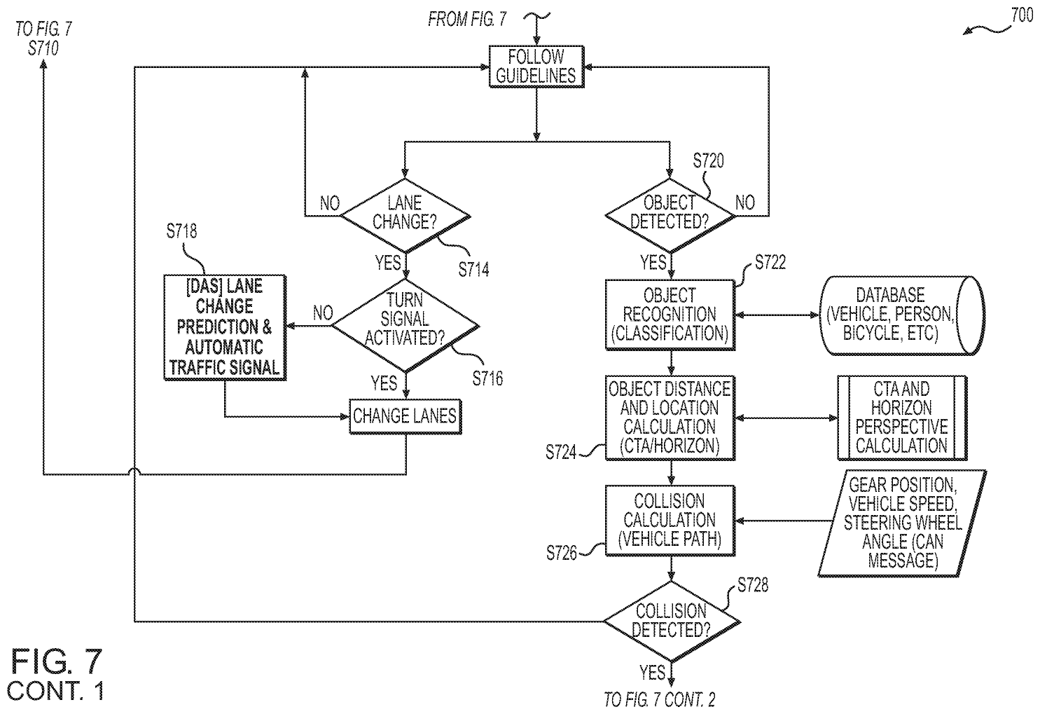

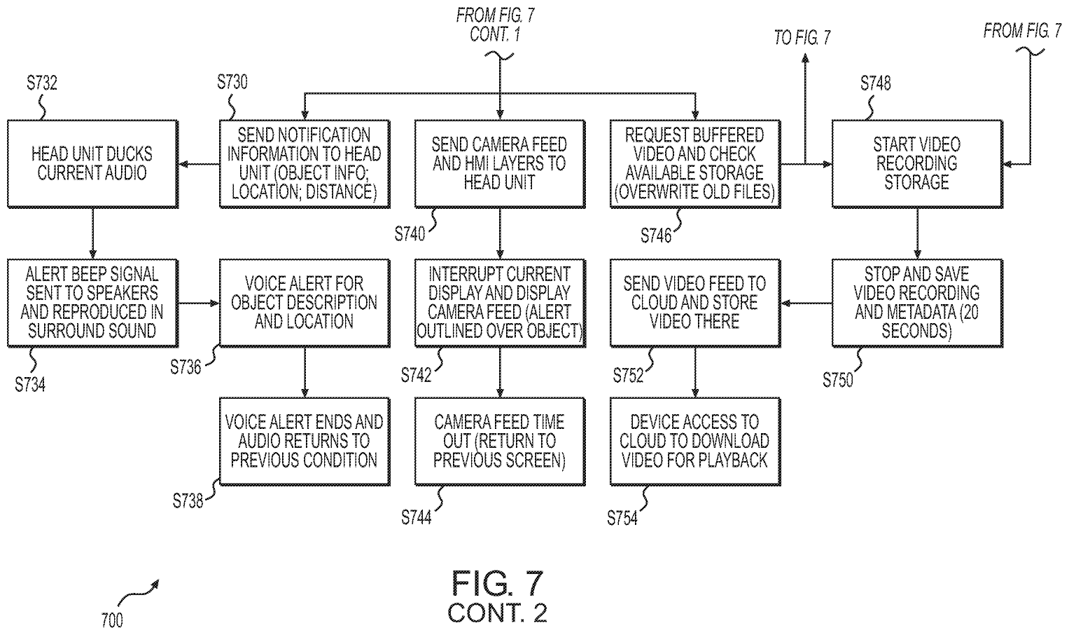

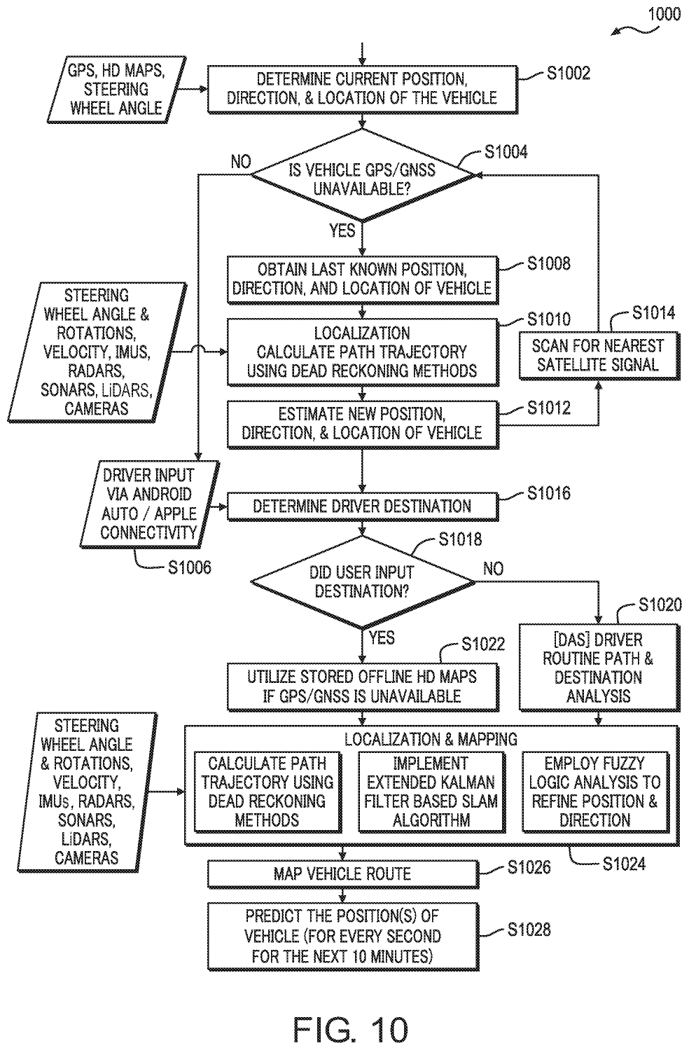

FIG. 7 is a flow diagram of a method 700 performed by a driving assistant module 106 of the DAS 100. In S703, the driver 118 starts the vehicle 102 and the MAV unit 110 turns on. The DAS 100 starts in park mode (S704), and in S706 collects image data from the vehicle cameras 328 and stiches them together to form a 3D surround view of the vehicle 102, which may be displayed to the driver 118 on the MAV display 112. At S707, the DAS 100 determines if the user input a destination to the system. If the user did not input a destination, the DAS 100 starts driver path prediction in S708. Driver path prediction will be discussed below with respect to FIG. 10. If the user entered a destination, or on receipt of a predicted destination from the driver path prediction, in S712 the DAS 100 starts the AR guidance module (e.g., method 400 discussed above.) When the driver 118 shifts into drive and drives forward (S710).

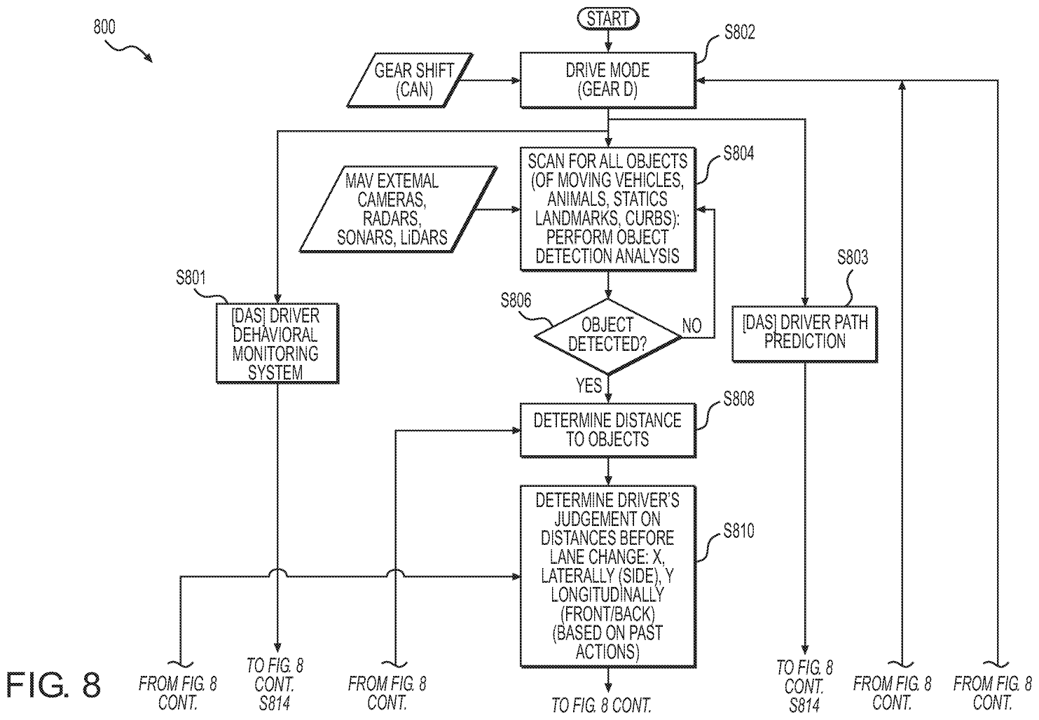

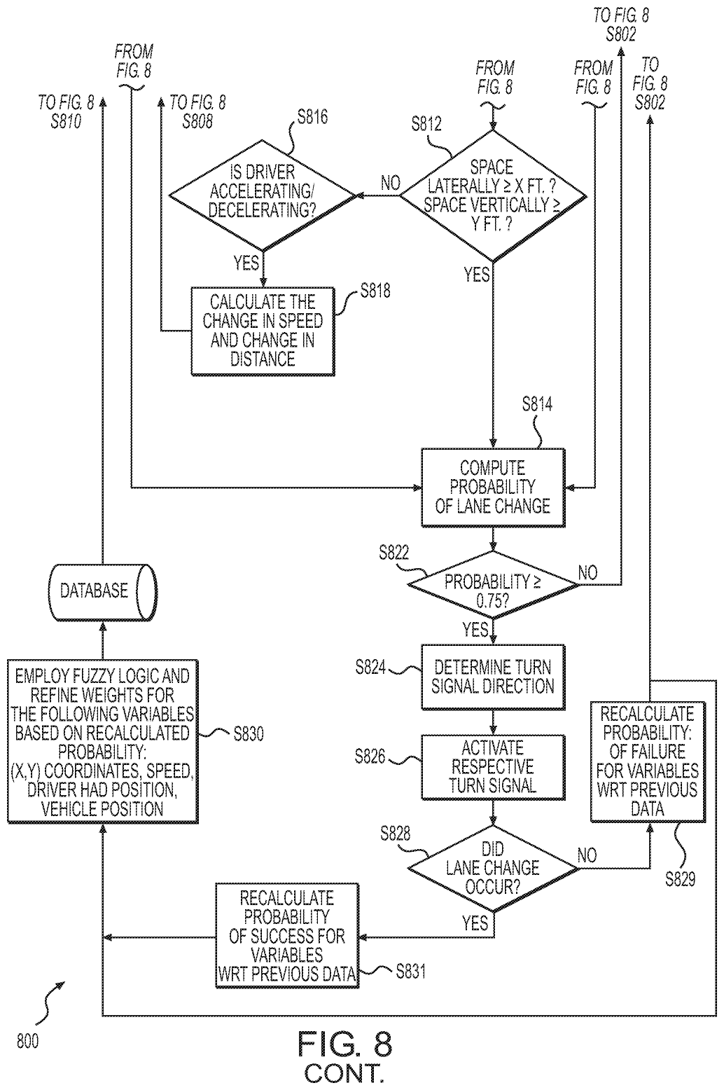

AS the driver follows the guidelines and drives forward, the DAS 100 monitors for detection of a lane change by the vehicle 102 in S714. If a lane change is detected, the system checks for activation of a turn signal of the vehicle 102 in S716. If a turn signal has not been activated, the DAS 100 continues to a lane change prediction and turn signal activation method that will be described below with respect to FIG. 8. If the turn signal was activated by the driver 118 or by the DAS 100, the method 700 returns to monitoring for detection of a lane change.

While monitoring for a lane change, the DAS also monitors for nearby objects in S720. If an object is detected, e.g., by the radar system, LIDAR system, the ultrasonic sensors, in the image data from the vehicle cameras 328, in S722 the DAS 100 attempts to recognize (e.g., classify) the detected object using an object detection database stored, for example, in memory 204. The recognition may be performed using any suitable technique for object recognitions. In S724, the system 100 calculates the location and distance of the object relative to the vehicle 102. In S726, the DAS 100 calculates the path of the vehicle 102 to determine if the vehicle is on a collision path with the detected object (S728). If the vehicle is on a collision path with the detected object, the DAS 100 provides an audio alert (S730-S738), a visual alert (S740-S744), and records video from the cameras 328.

The audio alert is output through the stereo 116. The audio alert may include an alert tone, a verbal warning, a recommended action to take to avoid the collision, an identification of the recognized object, a distance to the recognized object, and/or a time until collision with the recognized object. In some embodiments, the audio output is additionally or alternatively output through a user portable device (e.g., through the user's smartphone).

The visual alert is output through the MAV display 112. The visual alert may include video from the cameras 328, highlighting of the detected object in the video from the cameras 328, a warning indicator, a flashing indicator, a recommended action to take to avoid the collision a distance to the identified object, and/or a time until collision with the identified object. In some embodiments, a visual alert different than the visual alert sent to the MAV display 112 is additionally or alternatively output to the AR system 114 for display of a visual alert (though not the video from the cameras 328) on the AR glasses 300. The AR system 114 may for example, display a visual alert that highlights the recognized object (if the object is within the field of view of the driver), may display a text indication of a potential collision course, or display any other suitable visual alert.

FIG. 8 is a flow diagram of a method 800 of lane change prediction and automatic turn signal activation for S718 of the method 700. Generally, the DAS 100 predicts when the driver 118 is about to change lanes and activates the appropriate turn signal if the driver 118 has not activated the appropriate turn signal. The DAS system 100 refines its predictions using data from previous lane changes (and lack of lane changes) by the driver 118.

After entering drive mode (S802) by determining that the gear shift is in drive, the DAS 100 starts driver behavioral monitoring (S801) and driver path prediction (S803), described below with respect to FIGS. 9 and 10. At S804, the DAS 100 scans for objects around the vehicle 102 based on input from the cameras 328 and from proximity sensors such as ultrasonic sensor, radar, LIDAR, or other sensors and systems (e.g. some of the sensors 332) suitable for detecting objects near the vehicle 102. The nearby objects scanned for can include other vehicles, animals, static landmarks, trees, potholes, rocks, pedestrians, curbs, or any other suitable objects located around the vehicle 102. At S806, if no objects are detected, the DAS 100 continues scanning. If an object is detected, the DAS determines (S808) the distance to the detected object(s).

In S810, the DAS 100 determines the driver's judgment on distances before a lane change based on the driver's history of lane changes. The driver's ability is characterized by a distance x and a distance y. The distance x is the distance to in the lateral (side) direction of the vehicle 102, and the distance y is the distance in the forward/rear direction of the vehicle 102. The DAS 100 then, in S812, determines if the distance to the detected object is greater than or equal to the distances x and y. If the distance is less than the distances x and y, the DAS 100 determines (S816) if the driver is accelerating or decelerating. If the driver is accelerating or decelerating, the system calculates the change in the speed of the vehicle 102 and the change in distance to the other vehicle (S818) and returns to S808.

If the distance is greater than or equal to the distances x and y, at S814, the DAS 100 calculates the probability that the driver 118 will change lanes based on inputs from the driver behavioral monitoring system and the driver path prediction. If the probability of a lane change is less than 0.75 (i.e., less than 75%) in S822, the method 800 returns to S802. If the probability of a lane change is greater than or equal to 0.75, the DAS 100 determines to which direction the driver is going to change lanes (S824) and turns on the corresponding turn signal of the vehicle 102 (S826). If the lane change did not occur, at S828, the turn signal is turned off, and the DAS 100 recalculates the probability of failure (i.e., the probability of no lane change occurring) for the utilized variables with respect to the data utilized (S829). That is, the DAS 100 determines that there is a 100% chance that a lane change does not occur (or 0% chance a lane change does occur), and that the variables that were used to calculate that a lane change would occur (in S814) resulted in a 100% likelihood of no lane change occurring. The range of variables and the weighting applied to the calculations for estimating the probability of a lane change occurring can then adjusted for use in future computations of the probability of a lane change occurring. The method returns to S802.

Similarly, if the lane change did occur, in S831, 100 recalculates the probability of a lane change occurring for the utilized variables with respect to the data utilized (S829). That is, the DAS 100 determines that there is a 100% chance that a lane change does occur (or 0% chance a non-occurrence of a lane change), and that the variables that were used to calculate that a lane change would occur (in S814) resulted in a 100% likelihood of a lane change occurring.

In S830, the recalculated probability (of wither a lane change in S831 or a failure in S829) are used to adjust the variables and weights used in computing the probability of a lane change in S814. More specifically, fuzzy logic is used to refine the calculations and weights based on the recalculated probability for: the distances x and y, the vehicle speed, the driver's head position, and the vehicle position. The updated results are stored in a database (for example in memory 204 for future use.

FIG. 9 is a flow diagram of a method 900 of driver behavioral monitoring for step S801 in the method 800. Generally, the method 900 monitors the driver's behavior to aid in determining whether the driver is about the change lanes and stores data about the behavior and the associated lane change occurrence or non-occurrence for future use.

In S902, the DAS 100 monitors the driver's eyes and head movement. The DAS monitors the eye and head movement of the driver 118 through the interior camera 329, the AR glasses 300 (e.g., through the sensors of the AR glasses and/or a camera on the AR glasses 300 that images the driver's eyes). The system 100 processes the images (and other relevant data collected) in S904. In S906, the DAS 100 calculates the driver's head and eye positions. In particular, the change (if any) in the position of the driver's irises is determined and any rotation of the driver's head is determined and the number of degrees of such a rotation are determined. In other embodiments, only head rotation or only eye position is used.

In S908, the calculated head and eye positions are compared to previously learned and stored data from previous lane changes and/or predicted but non-occurring lane changes. Based on this comparison, the DAS 100 calculates a probability of a lane change occurring in S910, and determines which direction (left or right) the head and/or eyes of the driver 118 turned in S912. In S914, the probability of a lane change and the direction of the head/eye movement are communicated to S814 of the method 800.

In S916, it is determined whether or not the lane change occurred. If it did not occur, in S918, the probability of a lane change not occurring is calculated. If a lane change did occur, the probability of a lane change occurring is recalculated in S920. In S922, the images from S902 (and, if applicable, other sensor data relied upon) are grouped and associated with the calculated probability. These images and calculated probabilities are then categorized in S924 with any other images and probabilities from previous iterations and grouped in groups that each covers a range of probabilities (and that together cover the entire range from 0.0 to 1.0). This categorizing is performed using fuzzy logic analysis. In other embodiments, any other suitable technique may be used. The categorized captures are used in S926 for to train a supervised learning network using Bayesian framework analysis and a database (e.g., in memory 204) of images and probabilities is updated in S928.

FIG. 10 is a flow diagram of a method 1000 of driver path prediction for S803 in the method 800. Generally, the method 1000 is used by the DAS 100 to predict a destination of the driver and a route to travel to the destination.

In S1002, the DAS 100 determines the current position, direction of travel, and location of the vehicle 102 based on data from the GPS sensor, maps stored, for example, in memory 204, and the steering wheel angle. If GPS or other global navigation satellite system (GNSS) is available in S1004, the DAS 100 checks for driver input of a destination, such as via the driver's portable device or via entry on the MAV unit 110 (S1006). If GPS or other GNSS is unavailable, the last known position, direction of travel, and location of the vehicle 102 (S1008), and in S1010 performs localization to calculate the path traveled by the vehicle 102 since the last known position using dead reckoning techniques based on steering wheel angle and rotation data, vehicle velocity data, IMU data, radar data, sonar data, LIDAR data, and/or camera images/data. In other embodiments, other techniques may be used to determine the path of the vehicle since the last known position. In S1012, the DAS 100 estimates the current position, direction of travel, and location of the vehicle 102 based on the last known position and the calculated path traveled by the vehicle, and continues to look for an available satellite signal for the GPS/GNSS (S1014).

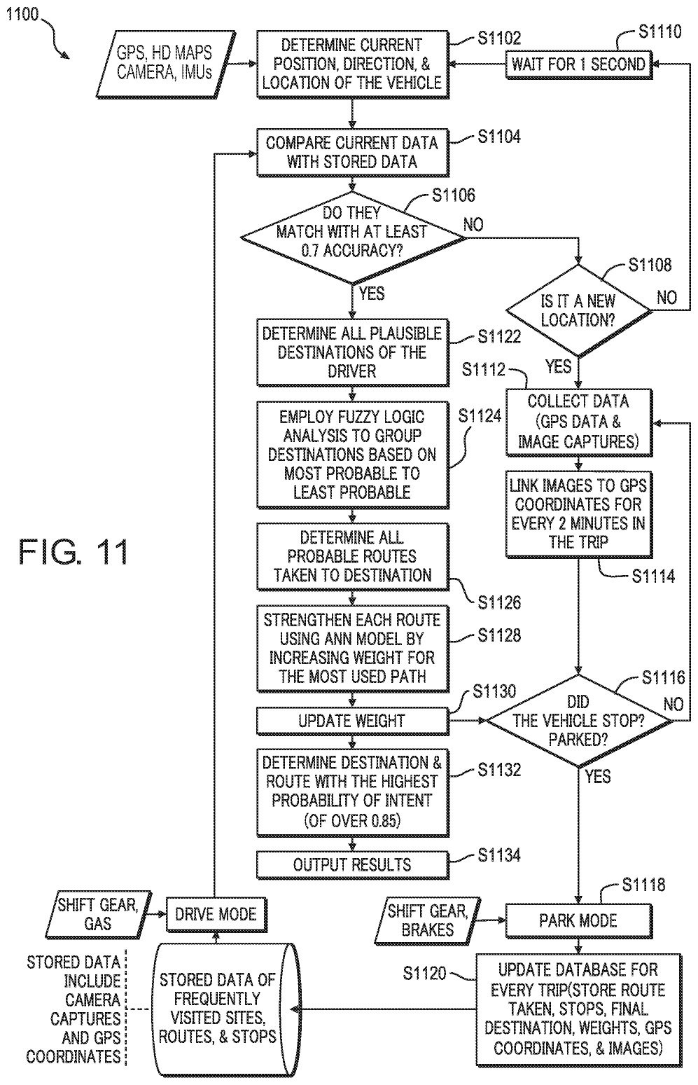

In S1016, the DAS 100 begins trying to determine the driver's destination. In S1018, the system determines if the driver 118 input a destination. If the user did not input a destination, a driver routine path and destination method is employed (S1020), which will be described below with reference to FIG. 11. If the driver did input a destination, the system retrieves maps for routing in S1022. If the GPS is available, the system 100 uses maps from the GPS. If the GPS is not available, offline maps stored in the memory 204 are used. Localization and mapping begins in S1024. In S1024, the vehicle path trajectory is calculated using dead reckoning methods, an extended Kalman filter based Simultaneous Localization and Mapping (SLAM) algorithm is executed, and fuzzy logic analysis is used to refine the position and direction. In S1026, a route for the vehicle to reach the destination is mapped using any suitable route mapping technique. The position of the vehicle is predicted (S1028) for every second for the ten minutes to anticipate the position of the vehicle during the travel to the destination, for example until the vehicle reaches the destination. In other embodiments, the position may be predicted for intervals of more or less than one second and for a period of more or less than ten minutes, including not predicting the position at all, or predicting the positions for a period that is variable and corresponds to the length of time until the expected arrival at the destination.

FIG. 11 is a flow diagram of a method 1100 of driver routine path and destination analysis for S1020 of the method 1000. Generally, the method 1100 to attempt, when the driver 118 has not entered a destination, to predict the driver's destination based on stored data about previous trips.

In S1102, the DAS 100 determines the current position, direction of travel, and location of the vehicle 102 based on data from the GPS sensor, maps stored, for example, in memory 204, and the steering wheel angle. The current position is compared (S1104) to stored data about frequently visited destinations, frequently traveled routes, and frequent stops by the driver 118. If the current location matches (S1106) a situation in the stored data with an accuracy of at less than 0.7 (i.e., 70%), the DAS 100 determines if the current location is a new location (S1108).

If the current location is a known location (i.e., it is stored in the stored data), the DAS 100 waits one second (S1110) and returns to S1102. In other embodiments, the system 100 may wait a longer or shorter amount of time before returning to S1102.

If the current location is a new location, the DAS 100 collects GPS data and image data from the cameras 328 in S1112. The GPS data is linked (S1114) to the image data collected at each location periodically for the entire trip. In the example embodiment, the GPS data and the image data are linked for every 2 minutes of the trip, but in other embodiments, they may be linked for longer or shorter intervals. In S1116, the DAS 100 determines if the car has been parked. If the car has not yet been parked, the method 1100 returns to S1112. If the car has been parked, the park mode is determined based on the sensor data from the gear shift and/or the brakes. In S1120, the stored data is updated with the newly collected data for the trip from the new location. The updated data may include the route taken, the stops made during the trip, the final destination, GPS data, and image data. Other embodiments may store different types of data (whether more or less).

If the current location matched stored data in S1106 with an accuracy of at least 0.7, all plausible destinations of the driver 118 are determined in S1122. Fuzzy logic analysis is used to group the plausible destinations from most probable to least probable (S1124). In S1126, the most probable routes are determined. An artificial neural network model is used to refine the routes by increasing the weighting of the most used routes in S1128. The weights are updated in S1130 based on the results. In S1132, the destination and route to that destination that have the highest probability and exceed a threshold probability are selected as the predicted destination and route. In the example embodiment, the threshold probability is 0.85. Other embodiments may use any other suitable probability threshold. In S1134, the predicted destination and route are output for use in the method 1000.

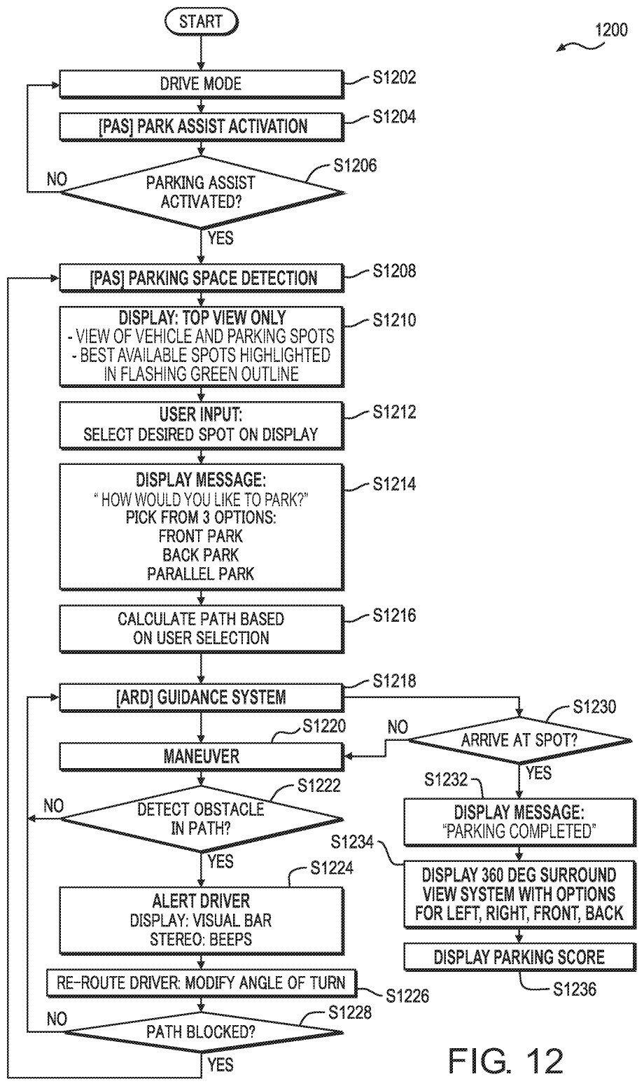

FIG. 12 is a flow diagram of a method 1200 performed by a parking assistant module of the DAS 100. Generally, the method 1200 assists the driver 118 in finding a parking space and parking the vehicle within the selected parking space.

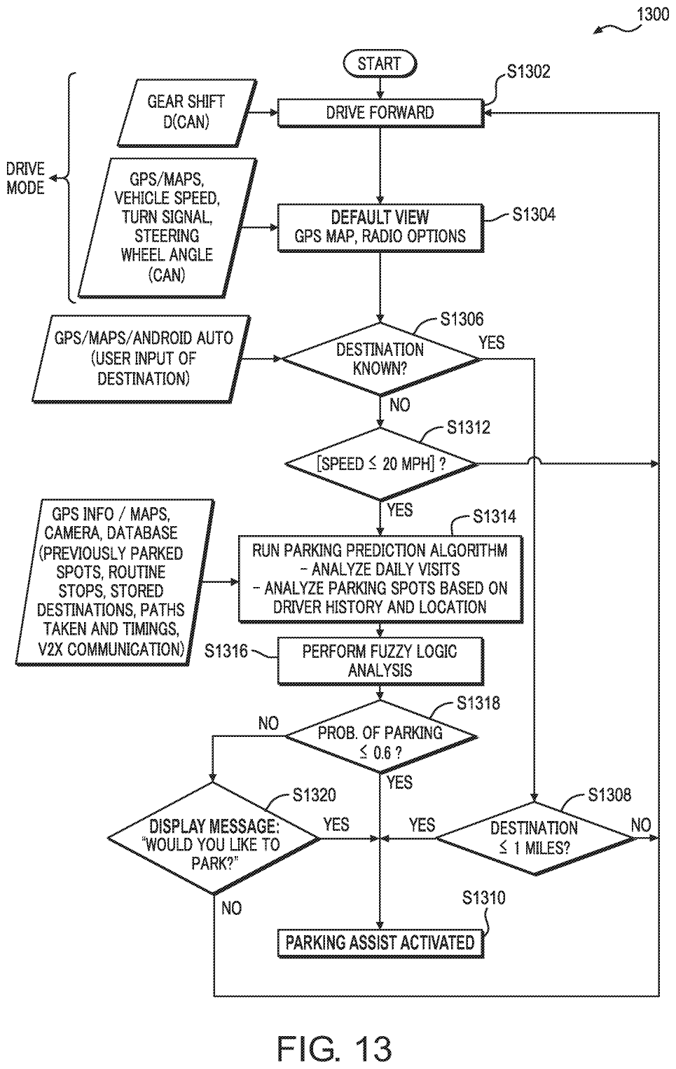

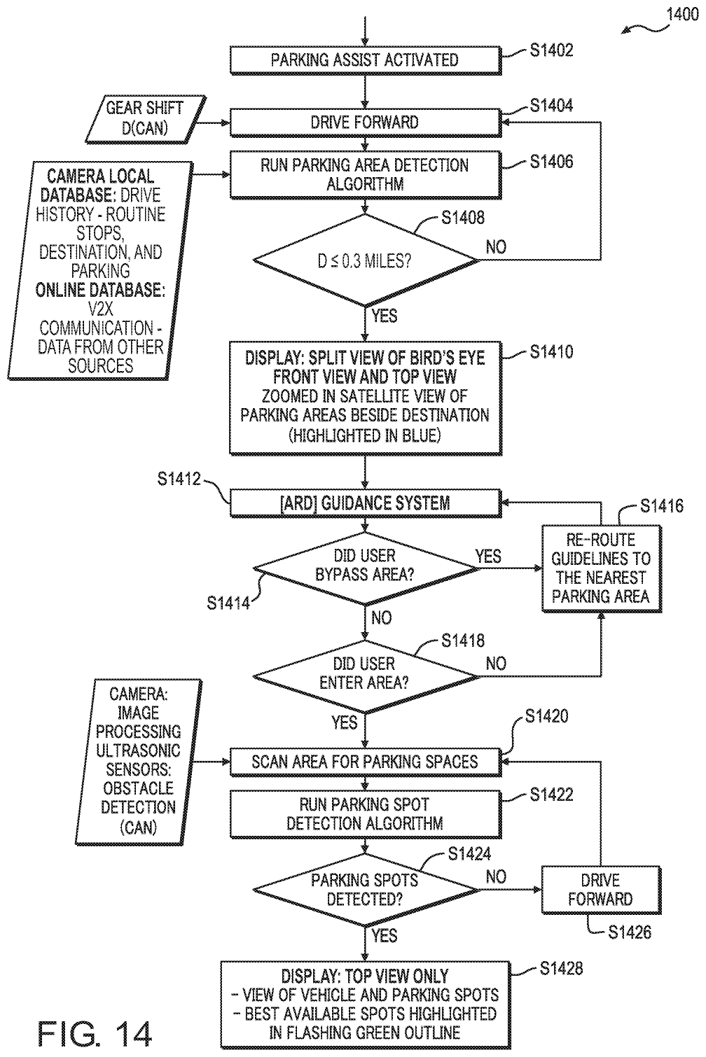

When in the drive mode (S1202), a parking assist activation method is performed at S1204, which will be discussed below with reference to FIG. 13. At S1206, the DAS 100 determines if parking assist has been activated. If parking assist has been activated, a parking space detection is performed (S1208), which will be discussed below with reference to FIG. 14.

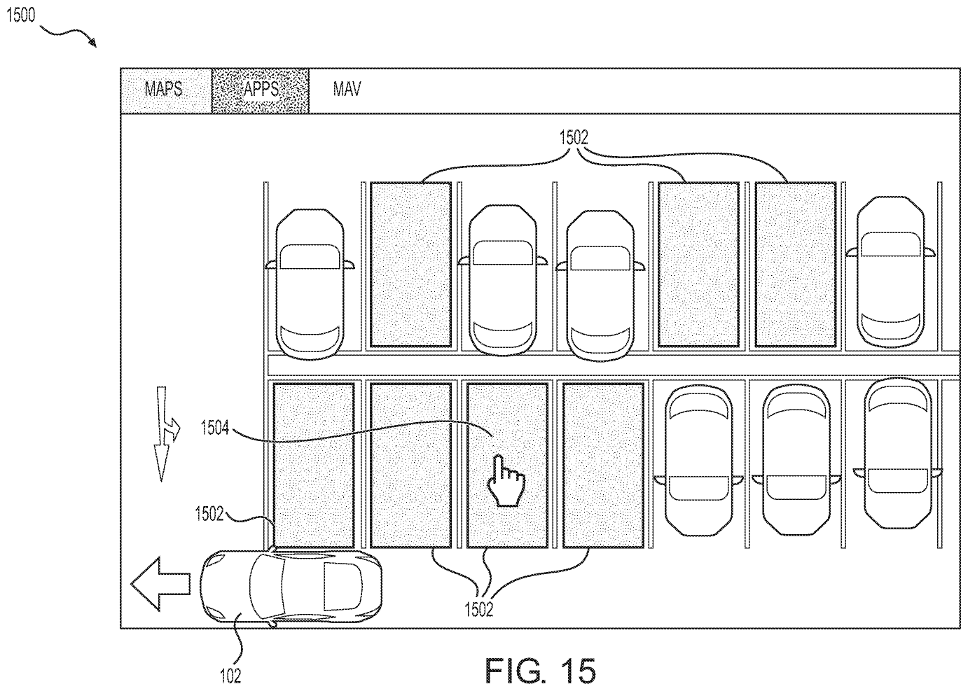

In S1210, a top view of the vehicle 102 and the parking spaces near the vehicle 102 are displayed on the MAV display 112. The top view image is stitched from images captured by the cameras 328. In other embodiments, the top view image may be wholly or partially generated from pre-existing images of the area around the vehicle, for example, from satellite images or maps of the parking lot. The best parking spaces (e.g., the closest parking spaces, the largest parking spaces, the parking spaces closest to the entrance to the destination location, or any other suitable criterion or criteria for determining the best parking spaces) that are available for parking (i.e., that are not occupied) are highlighted on the displayed image. FIG. 15 is an example top view image 1500 displayed on the MAV display during S1210. In FIG. 15, the available spaces 1502 are highlighted with a solid line box with a colored, translucent fill.

In S1212, the driver 118 selects one of the available parking spaces as the desired space in which to park the vehicle 102, such as by touching the space 1504 on the top view image 1500. The DAS 100 then displays to the driver 118 a message asking how the driver 118 would like to park in the selected parking space 1504 (S1214). For example, the driver can select to front park (drive forward into the parking space), back park (drive in reverse into the parking space), or parallel park. In some embodiments, the DAS 100 determines whether or not the selected space 1504 is a parallel parking space and does not provide the option to parallel park if the space 1504 is not a parallel parking space. Based on the driver's selection, the DAS 100 calculates the path to the selected space (S1216), and in S1218 guidance is provided to the driver 118 using the guidance method 400 (FIG. 4) discussed above.

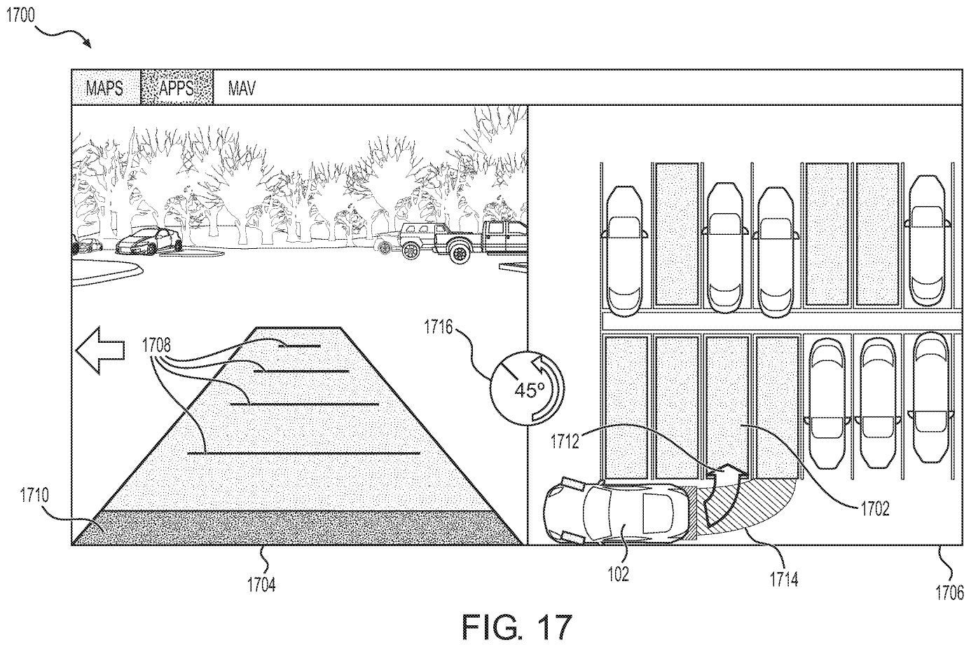

FIG. 17 is an example split view 1700 displayed on MAV display 112 to guide the driver 118 into the selected parking space 1702. In the split view 1700 a front view image 1704 and a top view image 1706 are displayed. Guidelines 1708 on the front view image help the driver 118 gauge the current path of the vehicle and the distance of objects in the image 1704 from the vehicle 102. A stop line 1710 indicates the area that should be kept without obstacles to avoid hitting them with the vehicle 102 (i.e., the driver should stop before an object in the image 1704 reaches the stop line 1710. When the driver 118 shifts the vehicle 102 into reverse (e.g., to back park into the selected space 1702), the front view image 1704 will be replaced by a similar back view image captured by a camera facing behind the vehicle 102. The top view image 1702 shows the driver 118 his vehicle 102, the selected parking space 1702, the desired path 1712 to successfully park in the parking space 1702, and the current path 1714 of the vehicle 102. A steering guide 1716 provides the steering change needed to achieve the desired path 1712. In some embodiment, the DAS 100 provide audio feedback to let the driver 118 know if the vehicle is on the desired path 1712 and/or how much correction is needed.

While the driver maneuvers (S1220) to the selected parking space, the DAS 100 monitors for obstacles (S1222) in the path of the vehicle 102. If an obstacle is detected, an alert is output (S1224) to the MAV display 112, the AR system 114, and/or the stereo 116. For the MAV display 112 and the AR system 114, the alert is a visual alert. For the stereo 116, the alert is an audio alert. In S1226, a new path to the parking space is calculated that avoids the obstacle. If the path is blocked (S1228), such that a path to the selected parking space cannot be determined, the method returns to S1208 and parking space detection is begun again. If the path is not blocked at S1228, the DAS continues to guide the driver 118 to the selected parking space.

At S1230, the DAS 100 determines if the vehicle 102 has arrived at the selected parking space. If the vehicle 102 has arrived, the DAS 100 informs the driver that parking is completed (S1232), displays a three hundred and sixty degree view around the vehicle 102 (with options for the driver 118 to select a left view, right view, front view, or back view from the vehicle 102 (S1234). Finally, a parking score is displayed to the driver 118. The parking score scores how well the driver parked the vehicle 102 in the parking space based, for example, on how straight the vehicle 102 is with respect to the parking space lines, how close the vehicle 102 is to the end of the parking space, how many corrections or attempts it took for the driver 118 to park the vehicle in the space, and the like. In some other embodiments, a parking score is not displayed to the driver 118.

FIG. 13 is a flow diagram of a method 1300 of parking assist activation for S1204 of the method 1200. Generally, the method 1300 detect when the driver 118 is likely to desire to park the vehicle 102.

As the driver 118 is driving the vehicle 102 forward (S1302), the MAV display 112 displays (S1304) its default view including, for example, GPS navigation maps, stereo controls, and the like. In S1306, the DAS 100 determines if the destination is known (discussed above with reference to FIG. 10). If the destination is known, the distance to the destination is compared to a distance threshold in S1308. The distance threshold is one mile. In other embodiments, the distance threshold may be more or less than one mile. If the distance to the destination is less than or equal to the distance threshold, parking assist is activated in S1310. If not, the method returns to S1302.

If the destination is unknown, the DAS 100 determines compare the speed of the vehicle 102 to a speed threshold in S1312. The speed threshold is twenty miles per hour (MPH). In other embodiments, the speed threshold may be more or less than twenty MPH. If the speed of the vehicle 102 is greater than the speed threshold, the method returns to S1302. If the speed of the vehicle 102 is less than or equal to the distance threshold, a parking prediction algorithm is run in S1314, based on GPS data, maps, camera images, and driver history data stored in the memory 204. In S1316, fuzzy logic analysis is performed to determine the probability of parking. In S1318, the determined probability of parking is compare to a probability threshold. The probability threshold is 0.6. In other embodiments, the probability threshold may be more or less than 0.6. If the probability threshold is greater than or equal to the probability threshold, parking assist is activated in S1310. If not, the DAS 100 displays on the MAV display 112 a message asking the driver 118 if the driver would like to park (S1320). If the driver selects yes, parking assist is activated in S1310. If the driver selects no, the method returns to S1302.

FIG. 14 is a flow diagram of a method 1400 of parking space detection for S1208 of the method 1200. Generally, the parking areas near the driver's destination and parking spaces near the vehicle 102 when the vehicle 102 arrives at the parking area.

When parking assist is activated (S1402) and the vehicle 102 is being driven forward (S1404), the DAS 100 runs a parking area detection algorithm in S1406. The algorithm uses images from the cameras 328, a local database (for example stored in memory 204), and an online database (stored remote from the vehicle 102 and accessed via one of the communications interfaces 208. The local database includes driver history, such as routine stops, routine destinations, routine parking areas, and the like. The online database includes data from other sources, such as parking maps, nearby parking areas, popular parking areas, availability of parking spaces at parking areas, and any other suitable data. In the example embodiment, the online database is accessed using V2X communication. In other embodiments, any other suitable communications technology may be used. The result of the parking area detection algorithm is an identification of a parking area near the driver's destination.

In S1408, the distance from the vehicle 102 to the identified parking area is compared to a distance threshold. The distance threshold in the example embodiment is 0.3 miles. In other embodiments, the distance threshold may be more or less than 0.3 miles. If the distance to the parking area is greater than to the distance threshold, the method returns to S1404. If the distance to the parking area is less than or equal to the distance threshold, the DAS 100 displays (S1410) a split view of a front view from the vehicle (captured by cameras 328) and a top view image showing the parking area near the destination. In the example embodiment, the top view image is a satellite image, but any other suitable top view image showing the parking area and the destination may be used. The identified parking area is highlighted in the top view image.

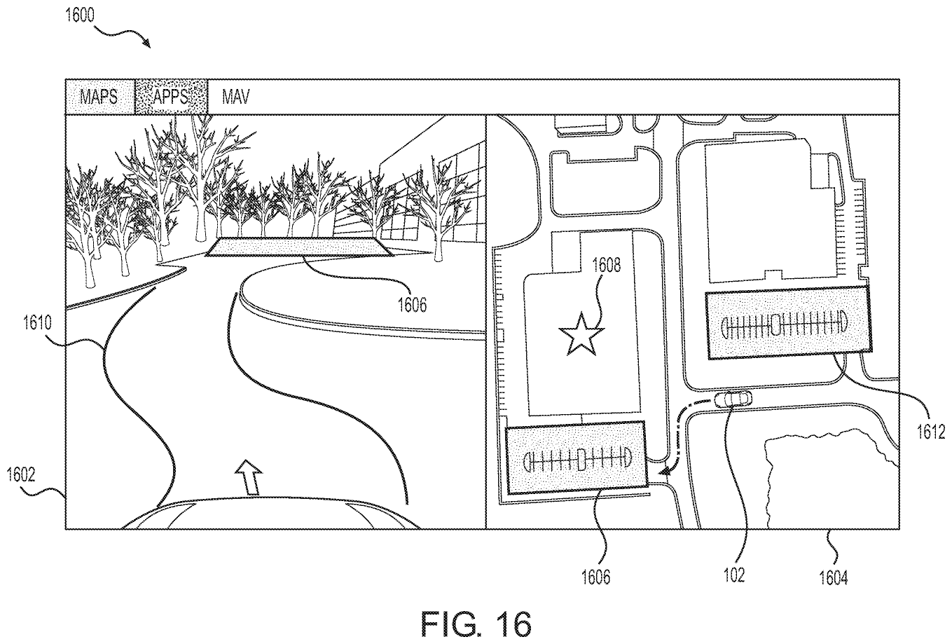

FIG. 16 is an example split view 1600 displayed on the MAV display 112 in S1410, including the front view image 1602 and the top view image 1604. The identified parking area 1606 can be seen highlighted in both images 1602 and 1606. The destination 1608 is also indicated (by a star graphic) in the top view image 1604.

In S1414 of FIG. 14, guidance is provided to the driver 118 using the guidance method 400 (FIG. 4) discussed above. In FIG. 16, the front view image 1602 includes guidelines 1610 to guide the driver 118 to the parking area 1606.

In S1414, the DAS 100 determines if the driver 118 passed the identified parking area. If the user passed the identified parking area, the DAS 100 reroutes (S1416) the guidelines to guide the driver to the next nearest parking area. For example, if the vehicle 102 in FIG. 16 turned right, rather than left, the DAS 100 may reroute the guidelines to direct the driver to the parking area 1612.

If the driver 118 does not bypass the identified parking area, the DAS determines if the vehicle has entered the parking area in S1418. If not, the guidelines are rerouted in S1416. If the vehicle 102 has entered the parking area, in S1420, the DAS begins scanning for parking spaces. Parking spaces are scanned for using images from the cameras 328 (using suitable image processing) and/or data from ultrasonic sensors (and suitable obstacle detection). The parking spot algorithm is run in S1422, and the DAS 100 determines if any parking spaces have been detected in S1424. If no spaces have been detected, the driver 118 continues to drive forward (S1426), and the method returns to S1420. If parking spaces were detected, a top view image of the vehicle 102 and the available parking spaces is displayed in the MAV display 112. FIG. 15 (discussed above) is an example of such a display

The DAS system described herein improves over known systems at least through several features that enhance safety efficiently and cost effectively. The DAS is a smart DAS including a driver assistant guidance system, which employs a smarter GUI method on the MAV display and through the interface of AR glasses. The DAS includes an enhanced method to predict user's intention to change lanes while in drive mode and ensure that the turn signal is automatically activated based on the vehicle's motion. This can be accomplished through object detection of the road lines and employing ANN to learn driver's intention. This enhances safety and ensures the signal is activated every time a turn or lane changes take place even if the driver “forgets” to activate it. The DAS also employs the GUI on MAV display to assist the driver while in parked mode, while parking, and while driving. The DAS system also provides prediction of the driver's intention to park and detection of parking spaces, allowing automatic switching to parking mode and automatic provision of parking guidance.

Some example incorporating various features described above will now be provided.

In a first example a driver assistance system includes a processor and a memory. The memory stores instructions that when executed by the processor cause the processor to: receive sensor data from a plurality of sensors of a vehicle; determine that a driver of the vehicle intends to turn the vehicle from a first lane of a road to a second lane of the road adjacent to the first lane of the road; and turn on a turn signal of the vehicle on a same side of the vehicle as the second lane of the road.

A second example is the driver assistance system of the first example, wherein the instructions stored by the memory further cause the processor to determine that the vehicle has completely entered the second lane; and turn off the turn signal after determining that the vehicle has completely entered the second lane.

A third example is the driver assistance system of the first example, wherein the instructions stored by the memory further cause the processor to determine that the driver intends to turn the vehicle from the first lane to the second lane using fuzzy logic.

A fourth example is the driver assistance system of the first example, wherein the instructions stored by the memory further cause the processor to increase accuracy of determining when the driver intends to turn the vehicle from the first lane to the second lane through continuous machine learning using an artificial neural network.

A fifth example is the driver assistance system of the first example, further comprising the plurality of sensors.

A sixth example is the driver assistance system of the fifth example, wherein the plurality of sensors comprises sensors selected from: RADAR, LIDAR, ultrasound, an IMU, and cameras.

A seventh example is the driver assistance system of the first example, further including a display and a plurality of cameras configured to capture images of an environment external to the vehicle and provide the captured images to the processor. The instructions stored by the memory further cause the processor to display, on the display device, captured images from at least one camera of the plurality of cameras when the processor determines that the driver intends to turn the vehicle from the first lane to the second lane.

An eighth example is the driver assistance system of the seventh example, wherein the instructions stored by the memory cause the processor to display captured images from at least one camera configured to capture images of the environment on the same side of the vehicle as the second lane.

A ninth example is a driver assistance system including a display, a processor, and a memory. The memory stores instructions that when executed by the processor cause the processor to: receive global positioning system (GPS) data from a GPS receiver; receive image data from at least one camera; receive sensor data from a plurality of sensors; determine an intention of the driver to park the vehicle; identify a parking area; identify empty parking spaces at a location in the vicinity of the vehicle based at least in part on one or more of the GPS data, the image data, and the sensor data; generate an overhead image of the location using the image data; display the generated overhead image on the display; and overlay a visual indicator on the displayed overhead image at the empty parking spaces. The image data includes images of an environment external to the vehicle. The overhead image includes a plurality of parking spaces including the identified empty parking spaces.

A tenth example is the driver assistance system of the ninth example, wherein the instruction further cause the processor to: receive a selection of one of the empty parking spaces; determine a directional instruction for guiding the vehicle to a selected empty parking space based at least in part on the GPS data; and display the determined directional instruction on the display.

An eleventh example is the driver assistance system of the ninth example, wherein the instruction further cause the processor to: receive a selection of a direction of parking in the selected empty parking space; and display image data from at least one camera of the plurality of cameras when the vehicle approaches the selected empty parking space, the at least one of the plurality of cameras being configured to capture images of the selected empty parking space when the car is being parked in the selected direction of parking.

A twelfth example is the driver assistance system of the eleventh example, wherein the instruction further cause the processor to: determine a planned path of travel to park the vehicle in the selected empty parking space in the selected direction of parking; and display, on the display at least one image representing the planned path of travel over the displayed image data from the at least one camera of the plurality of cameras when the vehicle approaches the selected empty parking space.

A thirteenth example is the driver assistance system of the twelfth example, wherein the instruction further cause the processor to: determine, based at least in part on the sensor data, a predicted path of travel of the vehicle; display, on the display at least one image representing the predicted path of travel over the displayed image data from the at least one camera of the plurality of cameras when the vehicle approaches the selected empty parking space.

A fourteenth example is the driver assistance system of the thirteenth example, wherein the instructions further cause the processor to: output a human cognizable signal (e.g., a visible signal, an audible signal, a tactile signal, and the like) that varies based on how close the predicted path of travel is to the planned path of travel.

A fifteenth example is the driver assistance system of the fourteenth example, wherein the human cognizable signal is an audible signal.

Additional examples include method performed by the systems of the first through eight examples.

What is claimed is:

1. A driver assistance system comprising:
a processor;
a memory, the memory storing instructions that when executed by the processor cause the processor to:
receive global positioning system (GPS) data from a GPS receiver;
receive image data from at least one camera, the image data comprising images of an environment external to the vehicle;
receive sensor data from a plurality of sensors;
determine a visual alert to display to a driver of the vehicle based at least in part on one or more of the GPS data, the image data, and the sensor data;
determine a display position for the visual alert; and
output the visual alert and the display position to a driver-wearable see-through augmented reality (AR) device.

2. The driver assistance system of claim 1, wherein:
the instructions stored by the memory further cause the processor to determine a speed limit for a location of the vehicle based at least in part on the GPS data; and
the determined visual alert comprises the determined speed limit.

3. The driver assistance system of claim 1, wherein:
the instructions stored by the memory further cause the processor to determine a current speed of the vehicle based at least in part on the sensor data; and
the determined visual alert comprises the determined current speed.

4. The driver assistance system of claim 1, wherein:
the instructions stored by the memory further cause the processor to determine a directional instruction for guiding the vehicle to a selected destination based at least in part on the GPS data; and
the determined visual alert comprises the determined directional instruction.

5. The driver assistance system of claim 1, wherein:
the instructions stored by the memory further cause the processor to determine that another vehicle less than a threshold distance from a side of the vehicle; and
the determined visual alert comprises an indication that the another vehicle is less than the threshold distance from the side of the vehicle.

6. The driver assistance system of claim 5, wherein:
the instructions stored by the memory further cause the processor to determine the display position based on which side of the vehicle is less than the threshold distance from the another vehicle.

7. The driver assistance system of claim 1, wherein:
the image data includes forward-view image data approximating a view of the driver of the vehicle; and
the instructions stored by the memory further cause the processor to determine the display position based at least in part on the forward-view image data.

8. The driver assistance system of claim 7, wherein:
the instructions stored by the memory further cause the processor to determine a real world position; and
determine the display position as a position on the AR device that corresponds to the real world position as viewed by the driver.

9. The driver assistance system of claim 1, wherein:
the instructions stored by the memory further cause the processor to identify at least one object in the image data; and
the determined visual alert comprises the identification of the at least one object in the image data.

10. The driver assistance system of claim 4, wherein the selected destination comprises a parking space.

11. A method of providing driver assistance, the method comprising:
receiving, by a processor, global positioning system (GPS) data from a GPS receiver;
receiving, by the processor, image data from at least one camera, the image data comprising images of an environment external to the vehicle;
receiving, by a processor, sensor data from a plurality of sensors;
determining, by the processor, a visual alert to display to a driver of the vehicle based at least in part on one or more of the GPS data, the image data, and the sensor data;
determining, by the processor, a display position for the visual alert;
receiving, by a driver-wearable see-through augmented reality (AR) device, the visual alert and the display position from the processor; and
displaying, on a see-through display of the AR device, the visual alert at the display position.

12. The method of claim 11, further comprising determining a speed limit for a location of the vehicle based at least in part on the GPS data, wherein displaying the visual alert at the display position comprises displaying the determined speed limit at the display position.

13. The method of claim 11, further comprising determining a current speed of the vehicle based at least in part on the sensor data, wherein displaying the visual alert at the display position, comprises displaying the determined current speed at the display position.

14. The method of claim 11, further comprising determining a directional instruction for guiding the vehicle to a selected destination based at least in part on the GPS data, wherein displaying the visual alert at the display position comprises displaying the determined directional instruction at the display position.

15. The method of claim 11, further comprising determining that another vehicle less than a threshold distance from a side of the vehicle, wherein displaying the visual alert at the display position comprises displaying, at the display position, an indication that the another vehicle is less than the threshold distance from the side of the vehicle.

16. The method of claim 15, wherein determining the display position for the visual alert comprises determining the display position based on which side of the vehicle is less than the threshold distance from the another vehicle.

17. The method of claim 11, wherein:
the image data includes forward-view image data approximating a view of the driver of the vehicle; and
determining the display position for the visual alert comprises determining the display position based at least in part on the forward-view image data.

18. The method of claim 17, further comprising determining a real world position associated with the visual alert, wherein determining the display position for the visual alert comprises determining the display position as a position on the AR device that corresponds to the real world position as viewed by the driver.

19. The method of claim 11, further comprising:
determining, by the processor, an updated display position for the visual alert in response to a changed view of the driver, the updated display position corresponding to an updated position on the AR device that corresponds to the real world position as viewed by the driver with the changed view;
receiving, by the AR device, the updated display position; and
displaying, on a see-through display of the AR device, the visual alert at the updated display position.

20. The method of claim 11, further comprising identifying at least one object in the image data, wherein determining the visual alert to display to a driver of the vehicle comprises determining an identification of the identified at least one object for display as the visual alert.
